(19) United States
(12) Patent Application Publication
(10) Pub. No.: US 2026/0099375 A1
(43) Pub. Date: Apr. 9, 2026

(54) Dynamic GPU Resource Allocation Real-Time Reservation and Optimization

(71) Applicant: Bank of America Corporation, Charlotte, NC (US)

(72) Inventors: Maharaj Mukherjee, Poughkeepsie, NY (US); Carl M. Benda, Charlotte, NC (US); Rahul Uniyal, Uttarakhand (IN)

(21) Appl. No.: 18/906,307

(22) Filed: Oct. 4, 2024

(51) Int. Cl. G06F 9/50; G06F 11/34

(52) U.S. Cl. CPC G06F 9/5044; G06F 9/5033; G06F 11/3442

(57) ABSTRACT

Systems and methods for real-time optimization of GPU resource selection and usage for executing computational programs, particularly in environments requiring intensive parallel processing, such as machine learning models, are disclosed. The system divides the program into subdivisions based on specific computational requirements and uses a GPU resource matcher to assign suitable GPUs for each subdivision. A time predictor forecasts when GPU resources will be needed, while a GPU resource locator identifies available resources in a dynamic marketplace. The system uses a GPU optimizer to assess costs, allocate resources, and adjust GPU usage in real-time, considering factors like power consumption and carbon footprint. The invention includes real-time monitoring, resource reallocation, and backup mechanisms for handling GPU failures or unavailability. Additionally, a marketplace enables dynamic role-switching between GPU consumers and providers, optimizing cost-effectiveness. The system also minimizes memory transfer bottlenecks between CPU and GPU, ensuring efficient execution of computational tasks.

### TECHNICAL FIELD

The inventions disclosed herein pertain to the field of electrical computers and digital processing systems: resource management or control, which involves systems that allocate, schedule, and optimize the use of computer resources. In this invention, GPU resources are treated as critical computational tools required for the operation of AI models, and the invention presents methods for dynamically allocating and managing these resources in real-time. The invention enhances resource control systems by allowing for predictive scheduling and on-the-fly adjustments based on task-specific computational needs, ensuring that the right resources are available when necessary, leading to a more efficient use of computational assets

### DESCRIPTION OF THE RELATED ART

The world of artificial intelligence and machine learning is undergoing rapid growth, largely driven by the development of sophisticated models such as large language models (LLMs) and generative AI systems. These models rely on massive computational power to function, with much of that power being supplied by GPU banks. GPUs offer the necessary parallelization capabilities that enable the models to process vast amounts of data simultaneously, which is essential for training and fine-tuning these complex systems. However, as more organizations and researchers work on creating larger and more advanced models, the demand for GPU resources has skyrocketed. This demand has exceeded supply, resulting in a significant shortage of available GPUs. The global shortage of GPUs has not only made it difficult for smaller players to access the resources they need but has also driven up the overall cost of using GPUs, as organizations scramble to secure whatever resources they can find.

The shortage of GPUs is compounded by the fact that the development of foundational AI models can take months to complete. During this time, models must undergo continuous training, calibration, and testing, all of which require GPU resources to operate effectively. However, the unpredictable nature of GPU availability and varying requirements for different stages of model development make it difficult to plan ahead. Some stages of training may require intense GPU usage, while others may be more computationally lightweight, leading to inefficient use of resources when they are not allocated correctly. Model builders are left with the challenge of estimating their resource needs well in advance, often resulting in overestimations that lead to excessive costs, or underestimations that cause delays in project timelines.

Complicating this further is the fact that not all GPUs are created equal. Different GPUs are optimized for specific types of computations, such as matrix operations, vector processing, or convolutional tasks. As AI models become more complex, the nature of the computations they perform changes frequently during training. A GPU that is suitable for one phase of training may not be optimal for another phase, meaning that without proper resource allocation, model builders could end up using GPUs that are inefficient for their tasks. This leads to wasted computational power and time, both of which are crucial in AI model development. The inability to dynamically adjust GPU resources based on the specific computational needs of each phase of model training creates further inefficiencies.

Another problem that arises from the current state of GPU resource allocation is the lack of transparency in GPU resource markets. As companies compete to secure GPUs for their AI models, the pricing and availability of these resources can fluctuate dramatically. Some companies offer subscription-based models, while others offer GPUs through auctions or dynamic pricing schemes based on resource availability. However, without clear insight into how GPU resources are being used at different stages of training, model builders may end up paying more for resources that are not optimized for their specific tasks. This lack of clarity can make it difficult for companies to budget accurately for GPU usage, resulting in financial inefficiencies that impact project sustainability.

The challenge is further exacerbated by the increasing size of foundational models. These models are not only growing in complexity but also in the amount of data they need to process. This requires even more GPU resources to handle the larger datasets and more intricate computations. As the models grow, so too does the duration of training, which can stretch over several months. During this time, it is nearly impossible to predict how GPU prices and availability will change, leaving model builders vulnerable to market fluctuations that can disrupt their projects. The inability to accurately forecast resource needs for extended periods adds to the uncertainty and difficulty of managing AI development projects.

Another key issue is that while some companies may have excess GPU resources at certain times, others may be in desperate need of them. There is currently no efficient way for organizations to exchange GPU resources in real time, which could alleviate some of the pressures caused by the GPU shortage. Instead, companies are forced to either hold on to unused GPU capacity or pay inflated prices to secure resources when they need them. This lack of flexibility in resource allocation further compounds the inefficiencies in the AI development ecosystem. The absence of a dynamic and transparent marketplace where GPU resources can be traded in real time limits the ability of organizations to adapt to changing project requirements.

As GPU resource needs grow, the long-term sustainability of AI projects is also being threatened. The increasing demand for GPUs has led to higher energy consumption, as more and more data centers are needed to meet the computational requirements of these models. This not only drives up the operational costs for companies but also raises concerns about the environmental impact of AI development. Without better resource management strategies, the energy consumption required to train large-scale AI models could become unsustainable, both financially and environmentally. The problem is not just about securing enough GPUs but about using them efficiently and in a way that minimizes waste.

Additionally, the current methods for accessing and reserving GPU resources are often manual and time-consuming. Companies must negotiate with GPU providers, monitor the market for availability, and make decisions about resource allocation without real-time data on what is happening within their AI models. This manual process introduces delays and increases the likelihood of human error, further slowing down AI development. The lack of automation in GPU resource management also makes it difficult for companies to scale their AI projects, as managing resources becomes increasingly complex as the size and scope of models grow.

The situation is particularly challenging for smaller organizations and startups, which may not have the financial resources to compete with larger companies in securing GPU capacity. As the demand for GPUs grows, these smaller players are often priced out of the market, limiting their ability to innovate and contribute to the AI ecosystem. This creates a barrier to entry for new companies and makes it difficult for them to compete with established players that can afford to lock in long-term GPU contracts or pay premium prices for resources. The lack of accessibility to GPU resources is a significant hurdle that stifles innovation and reduces the diversity of contributions to AI development.

Moreover, the inefficiencies in GPU resource allocation also impact the quality and speed of AI model development. When GPU resources are not optimized for specific tasks, it can take longer for models to converge, leading to delays in achieving the desired results. These delays can have a ripple effect throughout the entire development process, as teams must wait for each phase of training to complete before moving on to the next. The inability to access the right resources at the right time slows down innovation and makes it difficult for companies to meet the growing demand for AI-powered solutions.

Finally, the lack of real-time feedback during model training adds another layer of complexity to the problem. AI models are dynamic, and their computational needs change as they progress through different stages of training. Without real-time feedback on how GPU resources are being used, companies cannot make informed decisions about how to adjust their resource allocation strategies. This lack of visibility leads to inefficient use of resources and increases the risk of project delays or failures. The absence of a real-time monitoring system makes it difficult for companies to optimize their GPU usage, resulting in further inefficiencies.

There has long been a need for a system that can provide dynamic, real-time allocation of GPU resources based on the specific computational requirements of AI models. The current approaches to GPU resource management are fragmented and inefficient, leading to unnecessary costs, delays, and barriers to entry for smaller players. The shortage of GPUs has only intensified the need for a more efficient way to access and use these critical resources. The invention addresses this long-felt need by providing a solution that not only optimizes the use of available GPU resources but also enables real-time exchanges between consumers and resource owners, making the process more transparent, flexible, and accessible for all stakeholders involved.

### SUMMARY OF THE INVENTION

The inventions disclosed herein (collectively “invention” or “inventions”) represent a transformative approach to managing and optimizing the use of GPUs (Graphics Processing Units), especially in computationally intensive environments like training large-scale machine learning models. As GPUs play a crucial role in tasks requiring high parallelism, such as in the training of large language models (LLMs) and foundation models for artificial intelligence, the invention provides systems and processes that automatically manage the selection, allocation, and payment of GPU resources in real-time, ensuring cost efficiency and operational optimization. This approach allows users to dynamically select the most suitable GPU resources for specific computational tasks based on real-time availability and pricing, ensuring that costs are minimized and program execution remains uninterrupted.

The system operates by first analyzing the computational program that is to be run. It uses a specialized Program Analyzer to break down the program into smaller computational tasks or subdivisions. Each subdivision corresponds to a particular type of computation, such as vector operations, matrix multiplications, Fast Fourier Transformations (FFT), inverse FFTs, or convolutions. By analyzing the program in this granular manner, the system identifies the exact computational requirements for each task and prepares the groundwork for optimal GPU resource matching. This breakdown allows the system to make precise decisions about the type of GPU that should be used for each subdivision, ensuring that every task is matched to a GPU that is well-suited to handle the specific workload.

The core of the system's functionality lies in the ability of the GPU Resource Matcher to evaluate each subdivision and determine which type of GPU is best suited to handle the computational needs of that task. GPUs differ significantly in their architecture, with some being more adept at handling large-scale matrix operations, while others are optimized for smaller, more frequent calculations. The GPU Resource Matcher uses this knowledge to ensure that each computational task is assigned to the GPU that can perform it most efficiently. The ability to intelligently match each part of the program to a suitable GPU is a critical inventive feature of this system, as it ensures that the program runs efficiently without unnecessary delays or resource wastage.

Once the matching process is complete, the system must anticipate when each computational task will need to access GPU resources. This is achieved by the Time Predictor, which forecasts when each subdivision of the program will require GPU resources and for how long. The ability to predict resource needs over time is crucial in large-scale machine learning models, where training can take months or even longer. By predicting future resource requirements, the system ensures that GPUs are available exactly when needed, preventing costly delays caused by a lack of resources. Additionally, this predictive capability allows the system to engage in forward planning, booking GPU resources ahead of time to lock in lower prices when possible.

To find the appropriate GPUs that will be available during the predicted time frames, the system includes a GPU Resource Locator. This component scans available resources in a dynamic marketplace, identifying GPUs that meet the computational and time requirements for each subdivision of the program. The GPU Resource Locator interfaces with both major cloud providers, such as Amazon Web Services (AWS) and Google Cloud, as well as independent GPU owners who offer their resources for rent. The ability to search across multiple platforms and providers ensures that users always have access to a wide range of GPU options, increasing the likelihood of finding the most cost-effective solution for each task. The GPU Resource Locator also checks the cost of each available GPU and provides this information to the system, ensuring that the decision-making process remains cost-conscious.

The final decision on which GPUs to use for each subdivision is made by the GPU Optimizer. This component weighs multiple factors, including the recommendations from the GPU Resource Matcher, the availability of GPUs, and the cost data provided by the GPU Resource Locator. The GPU Optimizer's goal is to minimize the total cost of GPU usage while ensuring that the program can be completed within the desired time frame. The GPU Optimizer is designed to handle complex trade-offs between cost and performance, choosing GPUs that strike the optimal balance for the user's needs. For example, in cases where multiple GPUs are suitable for a particular task, the GPU Optimizer might choose a more expensive but faster GPU to reduce the total execution time, or it may select a slower, less expensive GPU to save costs if time is not a critical factor.

Once the system has selected the appropriate GPUs and assigned each subdivision of the program, the execution phase begins. This is handled by the GPU Consumer, a key component responsible for running the program on the allocated GPUs. The GPU Consumer monitors the program in real-time, ensuring that each subdivision is executed as planned. If there are any discrepancies during execution, such as a GPU becoming unavailable or a task taking longer than expected, the GPU Consumer updates the system with new time predictions and makes adjustments as needed. This real-time monitoring capability allows the system to be highly responsive and adaptable to changes, ensuring that GPU resources are used efficiently and that the program is completed without significant delays.

One of the unique aspects of this invention is its integration with a real-time marketplace for GPU resources. The marketplace allows GPU owners to rent out their GPUs when they are not in use, and it enables users to purchase GPU time on an as-needed basis. This real-time exchange creates a dynamic environment where supply and demand can be balanced in real time, allowing for the efficient allocation of resources. The marketplace model also introduces a new level of flexibility into GPU usage, as users are no longer required to commit to long-term contracts. Instead, they can pay for GPU resources on a per-use basis, allowing them to optimize their costs based on their actual needs.

Additionally, the invention introduces a novel role-switching mechanism that allows users to seamlessly transition between being a GPU consumer and a GPU provider. For example, a company that is using GPUs to train a machine learning model can later rent out those GPUs to other users once its training is complete. This dynamic role-switching capability maximizes the utilization of GPUs by ensuring that resources are never left idle. Users can assume the role of a provider when they have surplus GPU capacity and switch back to being a consumer when they need additional resources. This flexibility is a key inventive feature, as it ensures the continuous reallocation of GPU resources in response to changing demand.

The system also provides significant advantages in terms of cost optimization. Traditional methods for acquiring GPU resources often involve long-term contracts, which can be costly and inflexible. In contrast, this invention allows users to dynamically adjust their resource allocations in real-time, paying only for the GPU resources they actually need at any given moment. This flexibility ensures that users are not overcommitting to expensive GPU contracts, particularly in cases where their computational needs may change over time. By allowing users to adjust their resource allocations as their program progresses, the system minimizes waste and ensures that GPU resources are used as efficiently as possible.

Moreover, the system's real-time adaptability provides another significant advantage over existing methods. By continuously monitoring the execution of the program and making real-time adjustments to GPU allocations, the system ensures that any issues, such as a GPU becoming unavailable or taking longer than expected to complete a task, are addressed immediately. This real-time responsiveness is particularly valuable in environments where the availability and cost of GPU resources can fluctuate, allowing the system to always optimize for the best available options.

Another key inventive feature is the system's ability to integrate seamlessly with various GPU providers and platforms. The system is designed to work with major cloud platforms, including AWS, Google Cloud, and others, as well as with independent GPU owners who offer their resources through the marketplace. This interoperability ensures that users always have access to a wide range of GPU options, increasing the chances of finding the most suitable and cost-effective resources. The system's ability to connect with multiple platforms and providers also enhances its scalability, making it suitable for a wide range of users, from small companies to large enterprises.

In addition, the system's ability to predict future GPU needs and book resources in advance is a critical advantage. By looking ahead and anticipating when a particular computational task will require GPU resources, the system can take advantage of lower prices by booking GPUs ahead of time. This predictive capability allows the system to lock in better deals and optimize costs even further. The system's forward-looking approach to resource allocation represents a significant improvement over traditional methods, which often involve paying higher prices for GPU resources due to the lack of advance planning.

Furthermore, the invention's flexible pricing model is a major advancement over existing systems. By allowing users to engage in real-time auctions for GPU resources or choose from dynamic pricing models based on resource availability, the system ensures that users are always getting the best possible price for the resources they need. This flexibility in pricing is particularly important in a market where the cost of GPU resources can fluctuate significantly based on demand. By giving users the ability to choose the pricing model that works best for them, the system helps to further optimize costs and improve efficiency.

In conclusion, the invention offers a comprehensive solution for managing and optimizing the use of GPU resources in real-time. Through its combination of program analysis, GPU matching, resource prediction, cost optimization, real-time monitoring, and marketplace integration, the system provides a flexible and scalable approach to GPU resource management. The ability to dynamically allocate resources based on real-time needs, combined with the system's cost optimization features, makes it a significant advancement in the field of computational resource management. This invention is poised to play a crucial role in helping companies efficiently manage the GPU resources needed to train large-scale machine learning models, ultimately reducing costs and improving overall system performance.

In light of the foregoing, the following provides a simplified summary of the present disclosure to offer a basic understanding of its various parts. This summary is not exhaustive, nor does it limit the exemplary aspects of the inventions described herein. It is not designed to identify key or critical elements or steps of the disclosure, nor to define its scope. Rather, it is intended, as understood by a person of ordinary skill in the art, to introduce some concepts of the disclosure in a simplified form as a precursor to the more detailed description that follows. The specification throughout this application contains sufficient written descriptions of the inventions, including exemplary, non-exhaustive, and non-limiting methods and processes for making and using the inventions. These descriptions are presented in full, clear, concise, and exact terms to enable skilled artisans to make and use the inventions without undue experimentation, and they delineate the best mode contemplated for carrying out the inventions.

In some arrangements, a method for optimizing selection and use of GPU resources in real-time for executing a computational program is provided. The method comprises dividing, by a program analyzer, the computational program into subdivisions based on specific computational requirements of each part of the computational program. It further includes determining, by a GPU resource matcher, a suitable type of GPU for each of said subdivisions based on the computational requirements. A time predictor is used to predict when the subdivisions will require GPU resources and the duration of the need. The GPU resource locator locates available GPU resources in a marketplace, identifying GPUs that meet the subdivision requirements and will be available at the predicted time. A GPU optimizer assesses the cost of the located GPU resources for the predicted time and determines the most cost-effective resource to use. The GPU optimizer also allocates selected GPU resources for the subdivisions based on suitability and cost-effectiveness. The method involves executing, by a GPU consumer, the subdivisions on the allocated GPU resources, monitoring their execution in real-time to ensure efficient resource use, and updating predicted time requirements if necessary. Finally, the GPU optimizer adjusts the allocation of GPU resources dynamically during program execution in response to changes in availability or performance.

In some arrangements, the method further comprises the program analyzer dividing the computational program based on predefined types of computations. These types may include, but are not limited to, vector operations, matrix multiplications, Fast Fourier Transformations (FFT), and inverse FFTs.

In some arrangements, the method includes the GPU resource matcher further selecting a suitable GPU based on the specific hardware architecture of the GPU. This selection may consider factors such as the number of cores, memory bandwidth, and clock speed of the GPUs.

In some arrangements, the method includes the time predictor estimating the required duration of GPU resources based on historical data of similar computational tasks and real-time performance metrics to improve the accuracy of resource prediction.

In some arrangements, the method includes the GPU resource locator identifying GPUs that are available across multiple platforms, including cloud-based providers and private networks, to expand the pool of resources available for allocation.

In some arrangements, the method includes the marketplace operating an auction-based system where GPU providers offer resources at dynamically adjusted prices based on real-time demand and availability.

In some arrangements, the method includes the GPU optimizer prioritizing the selection of GPUs that have the lowest power consumption, provided they meet the computational requirements of the program subdivisions, to improve energy efficiency.

In some arrangements, the method includes the GPU optimizer further considering the carbon footprint of the data center or GPU provider when selecting the most cost-effective GPU resource, taking environmental impact into account.

In some arrangements, the method includes dynamically adjusting the allocation of GPUs during the execution of the program. This adjustment is based on real-time updates from the GPU consumer regarding performance and resource availability to ensure efficient resource usage.

In some arrangements, the method includes the GPU consumer continuously monitoring GPU utilization and updating the predicted completion time for each subdivision of the computational program based on the actual performance of the GPUs.

In some arrangements, the method includes the GPU consumer issuing alerts to the GPU optimizer if a subdivision's execution falls behind schedule, allowing for adjustments to the allocation of GPU resources to prevent delays.

In some arrangements, the method includes the GPU optimizer reallocating unused or underutilized GPU resources from other programs in the marketplace to the current program to ensure timely completion.

In some arrangements, the method includes the GPU consumer evaluating the health of the allocated GPUs, checking for conditions such as overheating, underperformance, or hardware failure, and reporting the status to the GPU optimizer.

In some arrangements, the method includes the GPU optimizer reserving backup GPU resources that can be used in the event of hardware failure or unavailability during the program's execution to avoid interruptions.

In some arrangements, the method includes the GPU optimizer adjusting the cost model dynamically in response to fluctuations in marketplace prices for GPU resources over the duration of the program's execution, optimizing costs.

In some arrangements, the method includes the GPU optimizer implementing a cost-prediction model that estimates future GPU prices based on current marketplace trends and historical pricing data, allowing for more informed resource planning.

In some arrangements, the method includes the marketplace enabling users to rent out excess GPU resources to other users in real time, allowing for dynamic role-switching between GPU consumer and GPU provider depending on their real-time needs.

In some arrangements, the method includes the program analyzer further optimizing the subdivisions of the program to minimize memory transfer bottlenecks between the CPU and the GPU during execution, improving overall program efficiency.

In some arrangements, a method for optimizing selection and use of GPU resources in real-time for executing a computational program is provided. The method comprises dividing, by a program analyzer, the computational program into subdivisions based on specific computational requirements, including predefined types of computations such as vector operations, matrix multiplications, FFT, and inverse FFT. The GPU resource matcher determines the suitable type of GPU based on the hardware architecture, including factors like the number of cores, memory bandwidth, and clock speed. A time predictor forecasts when the subdivisions will need GPU resources and for how long, using historical data and real-time performance metrics. The GPU resource locator identifies GPUs across multiple platforms, including cloud-based providers and private networks, in a marketplace offering resources via auction-based systems with dynamic pricing. The GPU optimizer assesses power consumption, carbon footprint, and cost to allocate resources dynamically during execution. Real-time monitoring by a GPU consumer ensures efficient execution, while backup resources and cost-prediction models ensure flexibility and cost-effectiveness.

In some arrangements, a system for optimizing selection and use of GPU resources in real-time for executing a computational program is provided. The system comprises a program analyzer configured to divide the computational program into subdivisions based on specific computational requirements, such as vector operations, matrix multiplications, FFT, and inverse FFT. A GPU resource matcher is configured to determine suitable GPUs based on hardware architecture, considering factors such as the number of cores, memory bandwidth, and clock speed. A time predictor forecasts when the subdivisions will require GPU resources and for how long, using historical data and real-time metrics. A GPU resource locator identifies available GPUs in a marketplace, which includes cloud-based providers and auction systems with dynamic pricing. A GPU optimizer assesses cost, power consumption, and carbon footprint to allocate GPU resources dynamically, adjusting in real-time based on performance. The system includes a GPU consumer module for monitoring execution, backup resource allocation, and cost-prediction modeling for optimal resource use.

The following description and claims, in conjunction with the drawings—all integral parts of this specification—will clarify various features and characteristics of the current technology. Like reference numerals in the figures correspond to similar parts, enhancing understanding of the technology's methods of operation and the functions of related structural elements, as well as the synergies and economies of their combinations. Some of the processes or procedures described here may be implemented, in whole or in part, as computer-executable instructions recorded on computer-readable media, configured as computer modules, or in other computer constructs. These steps and functionalities may be executed on a single device or distributed across multiple devices interconnected with one another. However, it is important to acknowledge that the drawings primarily serve for descriptive and illustrative purposes and are not intended to delineate the limits of the invention. Unless contextually evident, the singular forms of “a,” “an,” and “the” used throughout the specification and claims should be interpreted to include their plural counterparts.

### BRIEF DESCRIPTION OF DRAWINGS

FIG. 1 depicts a system architecture diagram illustrating the key components of the GPU resource optimization system, including the program input module, program analyzer, GPU resource matcher, time predictor, GPU resource locator, GPU optimizer, allocation manager, GPU consumer, monitoring module, dynamic adjustment module, and cost prediction module, as well as their interactions with the GPU marketplace.

FIG. 2 depicts a data flow diagram that demonstrates how data moves between the various components of the system, such as the program analyzer, GPU resource matcher, time predictor, GPU resource locator, GPU optimizer, and GPU consumer, as well as the flow of subdivision results and timing updates during execution.

FIG. 3 depicts a process flow diagram showing the step-by-step process for optimizing GPU resource selection and usage, starting from program upload, subdivision creation, GPU matching, time prediction, resource location, cost optimization, allocation, execution, and monitoring, through to the completion of the program.

FIG. 4A depicts the first part of a sequence diagram showing the interactions between the user and the system components, including the program analyzer, GPU resource matcher, time predictor, GPU resource locator, and GPU optimizer, as well as the marketplace, for submitting programs, matching subdivisions to GPUs, and locating resources.

FIG. 4B depicts the continuation of the sequence diagram from FIG. 4A, illustrating the interactions between the GPU optimizer, allocation manager, GPU consumer, monitoring module, dynamic adjustment module, and backup manager during the execution of the program and the handling of performance issues or hardware failures.

FIG. 5 depicts a class diagram showing the structure of the system's core components as classes, including the program analyzer, GPU resource matcher, time predictor, GPU resource locator, GPU optimizer, allocation manager, GPU consumer, monitoring module, dynamic adjustment module, backup manager, marketplace, and cost prediction module, along with their attributes and methods.

### DETAILED DESCRIPTION

The inventions include systems and methods for optimizing the selection and use of GPU resources in real-time for executing computational tasks, particularly in environments that require intensive parallel processing such as machine learning models and large-scale computations. The system aims to automate the process of selecting the most suitable and cost-effective GPUs, dynamically adjusting allocations as needed, and ensuring efficient use of GPU resources. This is achieved by a series of interconnected components that work together to analyze a program's computational requirements, predict resource needs, and allocate GPU resources based on real-time availability and cost factors.

At the core of the invention is a program analyzer that breaks down the computational program into multiple subdivisions. Each subdivision is based on the specific computational requirements of the program, such as vector operations, matrix multiplications, or Fast Fourier Transformations (FFT). By dividing the program into distinct tasks, the system is able to match each part of the program with the most appropriate GPU. This subdivision is critical to ensuring that GPU resources are allocated efficiently, as different types of computations may require different types of GPUs for optimal performance.

Once the program is subdivided, the system uses a GPU resource matcher to determine which GPU is best suited for each subdivision. The GPU resource matcher evaluates the computational needs of each subdivision and matches them to the GPU that can handle the task most efficiently. This involves considering factors such as the GPU's architecture, including the number of cores, memory bandwidth, and clock speed. The ability to match specific computational tasks with suitable GPUs is a key aspect of the invention, as it ensures that the program can be executed in the most efficient and cost-effective manner.

The system also includes a time predictor, which is responsible for forecasting when each subdivision of the program will require GPU resources and for how long. This predictive capability allows the system to plan ahead, ensuring that GPU resources are available when needed. The time predictor makes its estimates based on historical data and real-time performance metrics, which allows it to anticipate resource needs with a high degree of accuracy. By predicting when resources will be required, the system can secure GPU resources in advance, preventing delays in execution.

To locate the appropriate GPUs for the program subdivisions, the system includes a GPU resource locator. The GPU resource locator searches a marketplace for available GPUs that meet the program's requirements and will be accessible at the predicted time. This marketplace can include cloud-based providers, private networks, and an auction-based system where GPUs are offered at dynamic prices based on real-time demand. By identifying GPUs from multiple sources, the system increases the likelihood of finding the best possible resource for each task, whether in terms of cost, availability, or performance.

A GPU optimizer is then used to assess the cost of the available GPUs and to make final decisions on which GPUs to allocate for each subdivision. The GPU optimizer takes into account not only the cost of the resources but also factors such as power consumption and carbon footprint. It prioritizes GPUs that offer the best balance between cost and performance, ensuring that the overall execution of the program is both efficient and environmentally conscious. The GPU optimizer is also responsible for making dynamic adjustments to resource allocations during program execution, responding to real-time changes in resource availability and program performance.

During execution, the system monitors the performance of each subdivision in real-time using a GPU consumer. The GPU consumer tracks GPU utilization and ensures that each subdivision is being executed as planned. If there are any deviations from the expected performance, such as a GPU becoming unavailable or a task taking longer than predicted, the GPU consumer updates the system and triggers adjustments as necessary. This real-time monitoring capability allows the system to remain highly adaptive and responsive, optimizing the use of GPU resources throughout the program's execution.

In addition to real-time monitoring, the system also includes a mechanism for dynamic role-switching between GPU consumers and providers. Users who own GPUs can rent them out when they are not in use, and users who need additional GPU resources can acquire them from others in the marketplace. This flexibility allows for more efficient use of GPUs, as resources that would otherwise remain idle can be reallocated to other tasks. The marketplace model ensures that GPU resources are always being used to their fullest potential, reducing waste and maximizing efficiency.

The invention also includes provisions for backup resources in case of hardware failure or unavailability. The GPU optimizer can reserve backup GPUs that can be brought online if the primary resources fail. This redundancy ensures that the program continues to run smoothly even in the event of unexpected issues, minimizing disruptions and ensuring that computational tasks are completed on time. The ability to reserve backup resources is a feature that enhances the reliability of the system.

Another important aspect of the invention is the inclusion of a dynamic cost-prediction model. This model allows the GPU optimizer to estimate future prices for GPU resources based on current marketplace trends and historical data. By predicting price fluctuations, the system can make more informed decisions about when to secure resources, potentially locking in lower prices and further optimizing costs. This predictive cost model adds an additional layer of efficiency to the system, ensuring that resources are acquired at the best possible price.

The invention is also designed to integrate seamlessly with a wide variety of platforms and GPU providers. It can interface with major cloud service providers such as Amazon Web Services (AWS) or Google Cloud, as well as with smaller, independent GPU providers. This interoperability ensures that the system can access a broad range of GPU resources, increasing the likelihood that users will be able to find suitable GPUs for their computational needs. The system's flexibility and scalability make it applicable to a wide range of use cases, from small-scale projects to large enterprise-level deployments.

In addition to its resource optimization capabilities, the invention is also designed to minimize memory transfer bottlenecks between the CPU and GPU during execution. The program analyzer takes memory constraints into account when subdividing the program, ensuring that memory-intensive tasks are allocated to GPUs that can handle them efficiently. This helps to prevent delays caused by memory transfer issues, improving the overall performance of the system.

Real-time adaptability is a key feature of the invention. The system continuously monitors the execution of the program and adjusts GPU allocations in response to changing conditions. For example, if the availability of GPUs changes or if the program's performance deviates from expectations, the system can reallocate resources dynamically to ensure that the program remains on schedule. This flexibility allows the system to optimize performance even in unpredictable environments, where resource availability may fluctuate.

The system's environmental considerations are also beneficial. By factoring in power consumption and carbon footprint when selecting GPU resources, the system helps to minimize the environmental impact of large-scale computational tasks. This is particularly important in industries where sustainability is a priority, as the system allows users to balance computational efficiency with environmental responsibility.

In summary, the invention provides a comprehensive solution for optimizing the selection and use of GPU resources in real-time. By combining program analysis, resource prediction, cost optimization, real-time monitoring, and dynamic resource allocation, the system ensures that computational programs are executed efficiently, with minimal delays and at the lowest possible cost. The integration of a dynamic marketplace, role-switching capabilities, and environmental considerations further enhances the system's versatility and sustainability, making it a valuable tool for organizations that rely on GPU-intensive computations.

The description of various example embodiments herein is intended to achieve the goals previously outlined, referencing the illustrations included in this disclosure. These illustrations depict multiple systems and methods for implementing the disclosed information. It should be recognized that alternative implementations are possible, and modifications to both structure and functionality may be made. The description details various connections between elements, which should be interpreted broadly. Unless explicitly stated otherwise, these connections can be either direct or indirect and may be established through either wired or wireless methods. This document does not aim to restrict the nature of these connections. In various configurations, terms such as “computers” and “machines” refer to devices that may be general-purpose or specialized for specific tasks, whether physical or virtual, and capable of network connectivity. These devices encompass all necessary hardware, software, and components known to skilled practitioners, including application-specific integrated circuits (ASICs), microprocessors, cores, or other processing units. These components execute, control, or implement various types of software, instructions, data, modules, processes, or routines. The terms used do not restrict the device type and should be broadly interpreted. Software, data, and executable code can reside on various physical, computer-readable storage devices, such as local memory, cloud-based storage, or network-attached storage. These can be stored in both volatile and non-volatile memory and may function autonomously or respond to specific triggers. These elements can be consolidated or distributed across multiple devices and stored in accessible memory systems such as distributed databases, big data infrastructures, blockchains, or distributed ledgers.

Networks and similar references refer to a broad range of communication systems, from local area networks (LANs) and wide area networks (WANs) to the Internet and cloud-based networks, supporting wired and wireless configurations. Specialized networks like digital subscriber line (DSL), frame relay, asynchronous transfer mode (ATM), and virtual private networks (VPN) are included. These networks utilize various hardware and software components, including modems, routers, firewalls, switches, and adapters, to facilitate communication. Networks are also equipped with virtual IP addresses and support multiple protocols like HTTPS, enabling effective packet-based data transmission and communication.

Generative Artificial Intelligence (AI) refers to AI techniques that learn from training data and generate new content, such as text, code, images, and audio. Generative AI systems, often powered by large language models (LLMs) like GPT-3, GPT-4, Meta LLaMA, and others, can be deployed through APIs, search engines, or chatbots. These models, which may be proprietary or open source, leverage deep learning methods and are generally governed by enterprise policies regarding AI and risk. Models such as BERT, T5, AlphaFold, Watson, Megatron, and others play a role in generating or interpreting language and content for various applications.

Generative AI and LLMs are utilized throughout this disclosure for tasks including natural language processing, data analysis, real-time processing, software development, and creative content generation. Specific functions include trend analysis, data classification, sentiment analysis, writing assistance, language translation, and decision-making support. These models enable capabilities like feedback learning, context determination, and comprehensive search operations, improving performance through iterative learning and feedback from human or system interactions. The wide range of applications supported by generative AI makes these systems a powerful tool in generating, analyzing, and managing information across diverse fields. All configurations and uses of these models are within the scope of this disclosure.

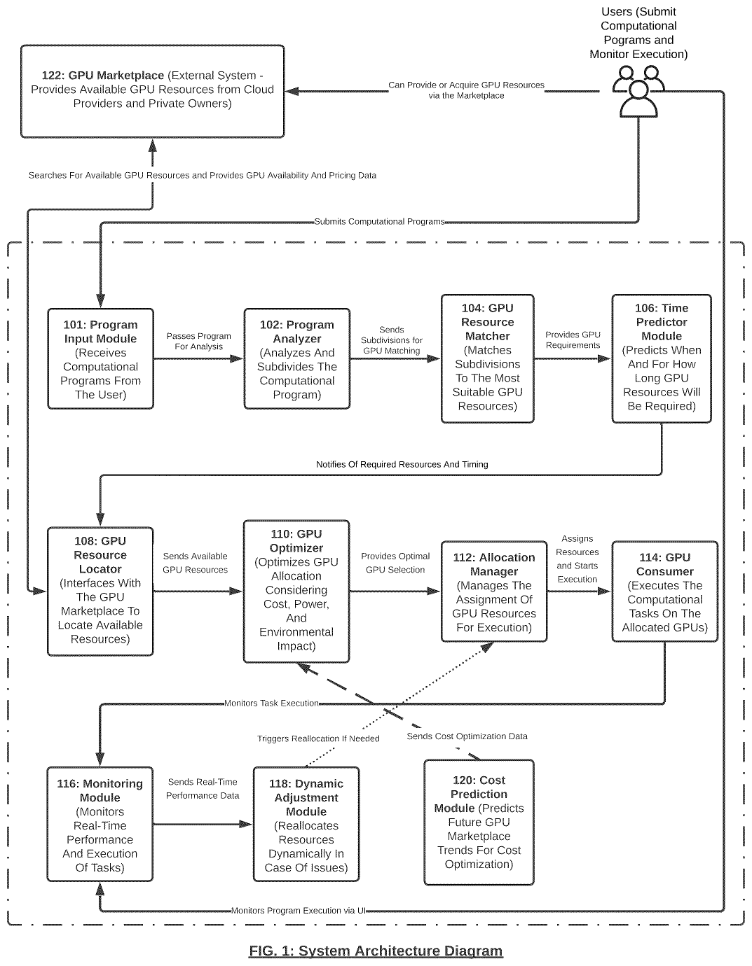

FIG. 1 illustrates a sample system architecture for optimizing the selection and use of GPU resources in real-time for executing computational programs. At the center of the system is the program input module, identified as element 101. This module serves as the initial interface for users to submit their computational programs. The program input module is designed to receive large-scale computational tasks that require high-performance GPU resources, such as training machine learning models, processing large datasets, or performing computationally intensive operations. The user submits the program, and it is passed into the system for further processing.

After the program is submitted, it moves to the program analyzer, shown as element 102. The program analyzer is responsible for breaking down the submitted program into multiple subdivisions. These subdivisions are defined based on the specific computational requirements of each portion of the program. Different computational tasks have varying needs, such as vector operations, matrix multiplications, Fast Fourier Transformations (FFT), and inverse FFTs. The program analyzer carefully analyzes the program and divides it into distinct subdivisions that can be handled more efficiently by GPU resources, ensuring that the system can optimize GPU allocation for each task.

Once the program has been subdivided, the GPU resource matcher, identified as element 104, plays a crucial role in the system. The GPU resource matcher evaluates each subdivision's computational requirements and matches it to the most suitable GPU. To do this, the matcher considers factors such as the GPU's architecture, including the number of cores, memory bandwidth, and clock speed. GPUs vary widely in their capabilities, and the matcher ensures that each task is allocated to a GPU that can handle the computation efficiently and effectively. This process is for optimizing the performance of the entire program and preventing delays caused by mismatched resources.

To ensure that GPU resources are available when needed, the system includes a time predictor module, shown as element 106. This module forecasts when each subdivision will require GPU resources and for how long. The time predictor bases its forecasts on historical data and real-time performance metrics, making it possible to anticipate the resource needs of the program at various stages of execution. By accurately predicting the timing and duration of GPU usage, the system can proactively reserve GPU resources, preventing idle time and ensuring smooth execution of the program.

The system also relies on a GPU resource locator, identified as element 108, to find available GPUs that meet the program's specific needs. This component interfaces with an external GPU marketplace, represented by element 122. The marketplace includes a variety of sources, such as cloud providers, private networks, and other GPU owners offering their resources. The GPU resource locator queries the marketplace to identify GPUs that match the specifications provided by the program analyzer and GPU resource matcher. It evaluates real-time availability, ensuring that the right GPUs are available at the predicted times when the program requires them. Once the available GPUs are located, the GPU optimizer, shown as element 110, takes over. The GPU optimizer evaluates multiple factors to determine the most cost-effective and efficient allocation of GPU resources. In addition to considering the suitability of the GPU for the computational task, the optimizer evaluates the cost of the GPU, its power consumption, and even its environmental impact, such as its carbon footprint. The optimizer balances these factors to select the optimal GPU for each subdivision of the program, ensuring that the program is executed as efficiently and sustainably as possible while keeping costs low.

With the optimal GPUs selected, the allocation manager, identified as element 112, is responsible for assigning the GPU resources to the program subdivisions. The allocation manager ensures that each subdivision is matched with the right GPU based on the optimization performed by the GPU optimizer. It coordinates the assignment process, ensuring that the resources are allocated without conflicts and that the execution of the program proceeds smoothly. Throughout the program's execution, the allocation manager monitors the resource assignments to ensure that they remain optimal.

The actual execution of the computational program is handled by the GPU consumer, shown as element 114. This component oversees the execution of each subdivision on the allocated GPUs. The GPU consumer initiates the program's execution by running each task on the selected GPU. During execution, the GPU consumer collects performance data and feeds it back into the system for real-time monitoring and adjustments. The performance data is for ensuring that the system can optimize resource usage throughout the program's runtime.

To monitor the performance of the system in real-time, the architecture includes a monitoring module, identified as element 116. This component tracks the performance of the GPUs and the overall progress of the program. The monitoring module continuously checks for performance bottlenecks, hardware issues such as overheating or underperformance, and other potential problems that could impact the efficiency of the program. This real-time monitoring allows the system to respond quickly to any issues that arise, minimizing delays and ensuring that the program continues to run optimally.

If performance issues are detected, the dynamic adjustment module, represented by element 118, comes into play. This module is responsible for making real-time adjustments to the GPU allocations based on the data provided by the monitoring module. If a GPU becomes unavailable, underperforms, or encounters hardware failure, the dynamic adjustment module can reallocate resources to ensure that the program execution continues without disruption. The dynamic adjustment module can also make proactive adjustments if it predicts that a resource is likely to underperform, providing an additional layer of flexibility and responsiveness.

In cases where resource availability becomes a problem, the system includes a mechanism for managing backup GPU resources, integrated into the overall allocation management process. The dynamic adjustment module works closely with the allocation manager to reassign resources or activate backup options, ensuring that the program execution is not interrupted. The system's ability to dynamically adjust resource allocations ensures that the program can continue even in the face of unexpected issues, enhancing the reliability of the execution process.

Finally, the architecture includes a cost prediction module, shown as element 120. This module predicts future GPU marketplace trends, particularly with regard to pricing. By analyzing historical pricing data and market trends, the cost prediction module helps the system make informed decisions about when to allocate resources. It provides valuable insights that allow the system to secure GPU resources at optimal times when prices are lower, thus reducing overall program execution costs. The cost prediction module also aids in long-term planning by predicting potential changes in the market that could affect resource availability and pricing.

The GPU marketplace, represented as element 122, plays a role in providing the external resources needed to execute the program. The marketplace includes a variety of GPU providers, including cloud service providers, private owners, and other GPU resource contributors. This marketplace allows the system to dynamically acquire additional GPU resources as needed, ensuring that the program can scale according to its requirements. It also enables role-switching, where users can act as either consumers or providers of GPU resources, adding a layer of flexibility to resource management.

In summary, FIG. 1 illustrates a sample of a comprehensive and robust system architecture for managing GPU resources. Each component, from the program input module (101) to the cost prediction module (120), plays a specific role in ensuring that GPU resources are allocated and utilized in the most efficient, cost-effective, and reliable way. The system's dynamic nature allows it to respond to real-time performance data, market fluctuations, and unexpected hardware issues, making it a powerful tool for executing computationally intensive programs on GPUs.

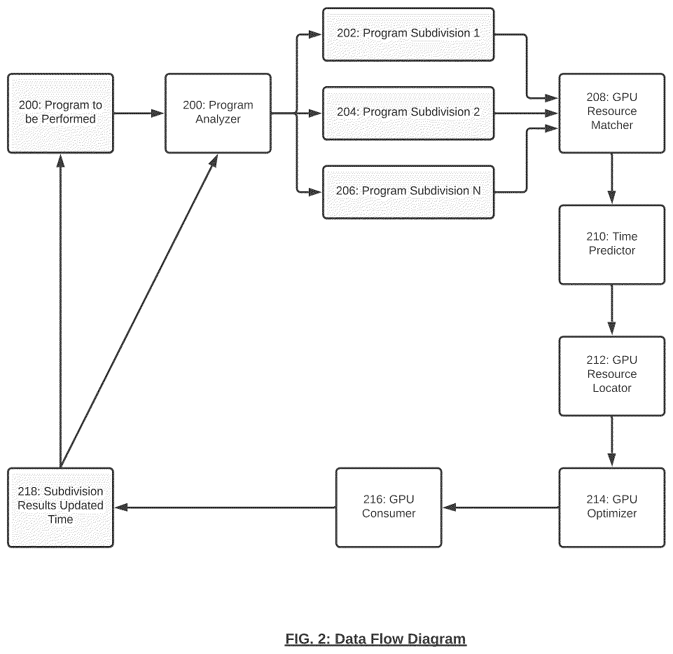

FIG. 2 depicts a detailed data flow diagram illustrating how information moves through the various components of the GPU resource optimization system as it processes and executes a computational program. The flow begins with the program to be performed, identified as element 200. This program is the user-submitted task that requires GPU resources for execution. The program is first passed to the program analyzer, also labeled as element 200 in this figure. The program analyzer is responsible for taking the entire program and breaking it down into smaller subdivisions based on the specific computational requirements of each portion of the task. These subdivisions enable the system to manage and allocate GPU resources more effectively by addressing the particular needs of each computational task.

As the program analyzer processes the input, it generates multiple subdivisions, represented by elements 202, 204, and 206, respectively corresponding to “Program Subdivision 1,” “Program Subdivision 2,” “Program Subdivision N,” etc. Each subdivision is an independent unit of computation that the system can handle separately. These subdivisions are created based on various computational operations within the program, such as vector operations, matrix multiplications, FFT, and inverse FFT. This subdivision of the program is key to the system's ability to allocate resources efficiently because it allows for targeted GPU resource allocation rather than treating the program as a monolithic entity.

The next step in the data flow is the interaction with the GPU resource matcher, shown as element 208. The GPU resource matcher receives the subdivisions generated by the program analyzer and evaluates the computational needs of each subdivision. The matcher's role is to identify the most suitable GPU for each specific subdivision based on factors like GPU architecture, including the number of cores, memory bandwidth, and clock speed. The matcher ensures that the most appropriate GPU is selected for each subdivision to optimize performance and prevent inefficient resource use.

Once the GPU resource matcher has evaluated the needs of each subdivision, the data is passed to the time predictor, labeled as element 210. The time predictor forecasts when each program subdivision will need access to GPU resources and how long those resources will be required. This prediction is based on historical data as well as real-time performance metrics gathered from previous executions of similar computational tasks. The time predictor is for ensuring that the system reserves the necessary GPU resources ahead of time, avoiding delays in execution and ensuring a smooth flow of operations.

After the timing predictions are made, the GPU resource locator, identified as element 212, takes over. The resource locator is responsible for finding GPUs that match the specifications provided by the program analyzer, the GPU resource matcher, and the time predictor. The locator interacts with a dynamic GPU marketplace to identify available GPUs that fit the program's requirements, both in terms of computational capability and availability at the predicted time. The resource locator's job is to secure the best available GPUs from cloud providers, private networks, or other sources participating in the GPU marketplace.

Once the available resources are identified, the GPU optimizer, shown as element 214, evaluates the different GPU options. The optimizer takes into account various factors, including one or more of the cost of the GPU, its power consumption, and its environmental impact. By balancing these considerations, the optimizer ensures that the system selects the most efficient and cost-effective GPU for each subdivision of the program. This optimization step helps reduce overall costs and improving the performance of the program execution.

After optimization, the data flow moves to the GPU consumer, represented by element 216. The GPU consumer is responsible for executing each subdivision on the allocated GPUs. During execution, the GPU consumer collects performance data and monitors the progress of the program. This real-time execution data is for feeding back into the system to ensure that everything is running smoothly and that any necessary adjustments can be made on the fly.

As the program executes, the subdivision results and timing are updated in real-time, shown as element 218. These updates are continuously monitored to ensure that the execution stays on track and that resources are being used efficiently. If any delays or performance issues arise, the system can adjust the resource allocation dynamically to correct the problem and keep the program running smoothly. The constant flow of updated data allows the system to remain flexible and responsive to changes in the execution environment, ensuring that the program can be completed without unnecessary delays.

In summary, FIG. 2 provides a clear and detailed view of how data moves through the various components of the system. Starting from the initial program input (200), the data flows through the program analyzer (200), where it is subdivided into smaller computational units (202, 204, 206). These subdivisions are then processed by the GPU resource matcher (208), time predictor (210), and GPU resource locator (212) to find and allocate suitable GPU resources. The GPU optimizer (214) ensures that the best GPUs are selected based on performance, cost, and environmental impact, while the GPU consumer (216) handles the actual execution of the program subdivisions on the allocated resources. Finally, the subdivision results and timing are continuously updated (218) to reflect the real-time status of the program execution, allowing the system to make dynamic adjustments as needed to ensure optimal performance and efficiency. This data flow architecture ensures that the system can handle complex computational tasks efficiently while minimizing costs and maintaining flexibility throughout the program's execution.

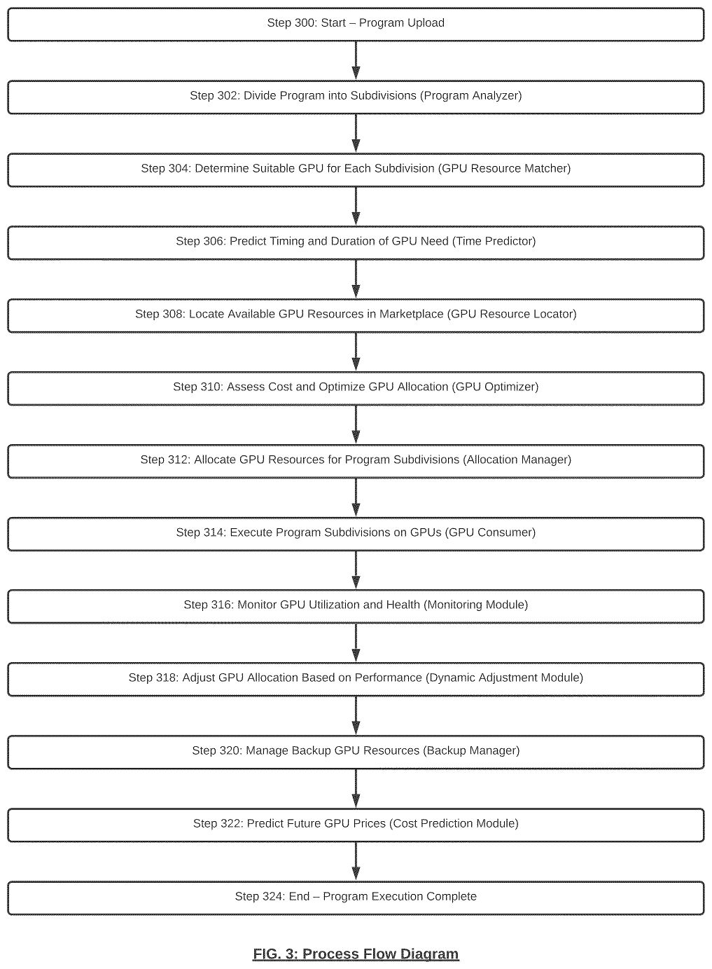

FIG. 3 presents a comprehensive process flow diagram that details the operation of the system for optimizing the selection and use of GPU resources in real-time for executing computational programs. The process begins at step 300, which is labeled as “Start-Program Upload.” In this initial phase, the user interacts with the system by submitting the computational program that requires GPU resources. The system is designed to handle complex, resource-intensive programs, such as those used for machine learning models or data processing. Once the user uploads the program, it enters the system for further analysis and processing.

Following the program upload, the system proceeds to step 302, where the program analyzer comes into play. This step is labeled “Divide Program into Subdivisions (Program Analyzer).” The program analyzer is responsible for breaking down the submitted program into smaller, more manageable subdivisions. Each subdivision represents a specific computational task or operation within the program. These tasks might include vector operations, matrix multiplications, Fast Fourier Transformations (FFT), inverse FFTs, or other complex calculations. By subdividing the program, the system can allocate GPU resources more efficiently, as each subdivision is treated as a distinct unit that requires different levels of computational power.

Once the program has been divided into subdivisions, the system moves to step 304, labeled “Determine Suitable GPU for Each Subdivision (GPU Resource Matcher).” At this stage, the GPU resource matcher evaluates the computational needs of each subdivision and determines which type of GPU is best suited to handle the specific task. GPUs vary in their architecture, and certain types of computations are better suited for specific GPUs. For example, a GPU with more cores and higher memory bandwidth may be necessary for large matrix multiplications, while a different GPU might be more efficient for vector operations. The GPU resource matcher ensures that each subdivision is matched with the most appropriate GPU to maximize performance and minimize execution time.

The next step in the process is step 306, labeled “Predict Timing and Duration of GPU Need (Time Predictor).” At this point, the time predictor forecasts when each subdivision will require GPU resources and how long those resources will be needed. The time predictor relies on historical data from previous program executions as well as real-time performance metrics to make accurate predictions. This step is essential for ensuring that GPU resources are available when needed and that they are reserved for the appropriate amount of time. By predicting the timing and duration of GPU needs, the system can plan ahead, reserving the necessary resources in the GPU marketplace to avoid delays in execution.

Once the timing and duration of GPU usage have been predicted, the process moves to step 308, labeled “Locate Available GPU Resources in Marketplace (GPU Resource Locator).” Here, the GPU resource locator searches for GPUs that meet the program's specific requirements. The locator interacts with a dynamic marketplace that includes various sources of GPUs, such as cloud providers, private networks, and other GPU owners who offer their resources for use. The GPU resource locator is tasked with identifying available GPUs that match the computational requirements of each subdivision and will be accessible at the predicted time. This marketplace is a component of the system, as it enables the system to scale according to the needs of the program, dynamically acquiring additional resources as required.

After identifying available GPU resources, the system proceeds to step 310, labeled “Assess Cost and Optimize GPU Allocation (GPU Optimizer).” In this step, the GPU optimizer evaluates the available GPU options to determine which ones offer the best balance of cost, performance, and efficiency. The optimizer takes into account several factors, including the cost of renting or using the GPU, its power consumption, and its environmental impact (such as carbon footprint). The optimizer's goal is to select GPUs that not only meet the program's performance requirements but also minimize costs and environmental impact. By considering these multiple factors, the system ensures that the most efficient GPUs are chosen, optimizing the allocation of resources and reducing the overall cost of executing the program.

Once the GPU optimizer has selected the appropriate resources, the system moves to step 312, labeled “Allocate GPU Resources for Program Subdivisions (Allocation Manager).” At this point, the allocation manager assigns the selected GPUs to the corresponding subdivisions of the program. The allocation manager ensures that each subdivision is matched with the appropriate GPU based on the optimization performed by the GPU optimizer. This step is for ensuring that the resources are distributed effectively and that the program can proceed without delays or resource conflicts. The allocation manager also monitors the ongoing execution of the program to ensure that the resource allocations remain optimal as the program progresses.

Following the allocation of resources, the system proceeds to step 314, labeled “Execute Program Subdivisions on GPUs (GPU Consumer).” In this phase, the GPU consumer takes responsibility for executing each subdivision of the program on the allocated GPUs. The GPU consumer is responsible for running the computational tasks on the GPUs and monitoring their performance during execution. As the program executes, the GPU consumer collects real-time performance data, which can be fed back into the system to ensure that resources are being used efficiently and that any necessary adjustments can be made.

The next step is step 316, labeled “Monitor GPU Utilization and Health (Monitoring Module).” At this point, the monitoring module continuously tracks the performance of the GPUs and monitors the overall progress of the program. The monitoring module checks for potential issues such as overheating, underperformance, or hardware failure. Real-time monitoring is for detecting problems early and ensuring that the system can respond quickly to any issues that arise. This step allows the system to maintain optimal performance throughout the execution of the program.

If any performance issues are detected during the execution, the system moves to step 318, labeled “Adjust GPU Allocation Based on Performance (Dynamic Adjustment Module).” The dynamic adjustment module is responsible for making real-time adjustments to the allocation of GPU resources in response to performance data provided by the monitoring module. For example, if a GPU begins to underperform or fails, the dynamic adjustment module will reallocate resources to ensure that the program continues running without significant delays. This ability to adjust resources dynamically adds a layer of flexibility to the system, enabling it to respond to unexpected changes in resource availability or performance during execution.

In cases where GPU resources become unavailable or fail, the system includes a backup mechanism at step 320, labeled “Manage Backup GPU Resources (Backup Manager).” The backup manager steps in when primary GPU resources are unavailable or fail to perform adequately. The backup manager is responsible for activating additional GPU resources that have been reserved as a backup. This step ensures that the program execution continues without disruption, even if unexpected hardware failures occur. The availability of backup resources enhances the system's reliability and ensures that programs can be completed on time.

The system also includes a cost management component, which comes into play at step 322, labeled “Predict Future GPU Prices (Cost Prediction Module).” In this step, the cost prediction module evaluates pricing trends in the GPU marketplace. The module analyzes historical pricing data and market trends to predict future GPU prices. This information helps the system make informed decisions about when to acquire GPU resources, allowing it to secure resources at optimal prices. By predicting future price fluctuations, the system can reduce costs and improve the efficiency of program execution over time.

Finally, the process concludes at step 324, labeled “End-Program Execution Complete.” At this stage, the program has been fully executed, and all program subdivisions have been processed on the allocated GPUs. The system marks the execution as complete, signaling the end of the process. This final step represents the successful completion of the computational program, with all resources having been used efficiently and all tasks completed on time.

In summary, FIG. 3 provides a detailed view of the system's operational process, from the initial program upload by the user to the final completion of the program. The system divides the program into subdivisions, matches each subdivision with the most suitable GPU, predicts the timing and duration of resource needs, locates available GPUs in the marketplace, optimizes resource allocation based on cost and performance, and monitors the execution in real-time. Throughout the process, the system adjusts resource allocations dynamically, activates backup resources if needed, and predicts future GPU prices to optimize costs. This detailed process flow ensures that computational programs are executed efficiently, with minimal delays and at the lowest possible cost. The system's dynamic and flexible approach to resource management allows it to adapt to changing conditions, ensuring reliable and efficient execution of complex computational tasks.

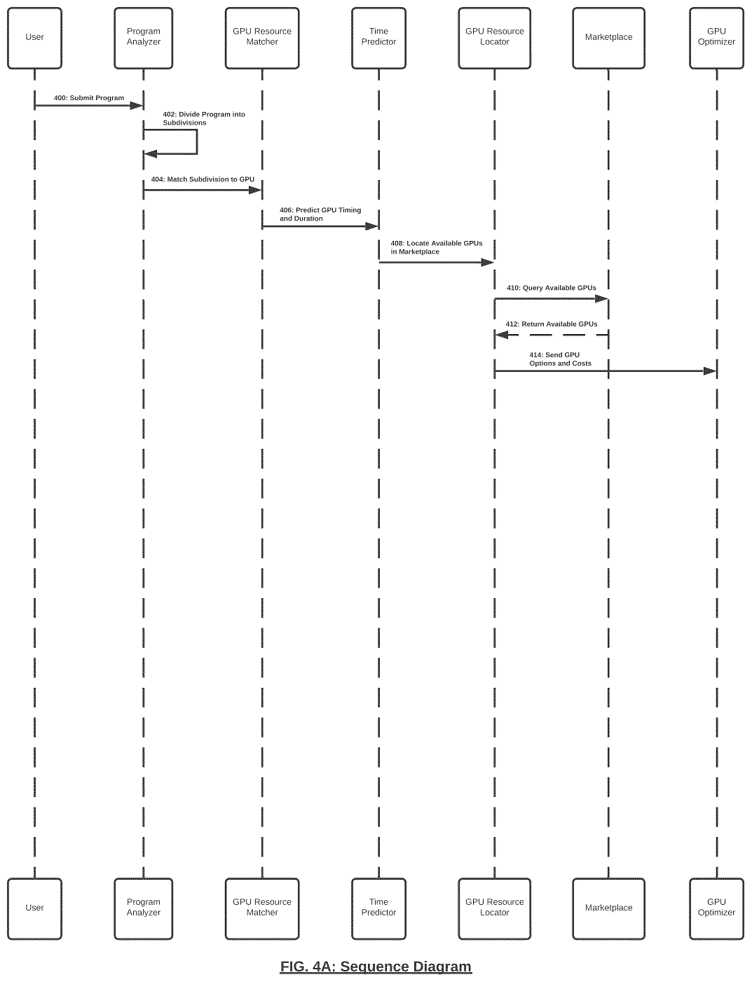

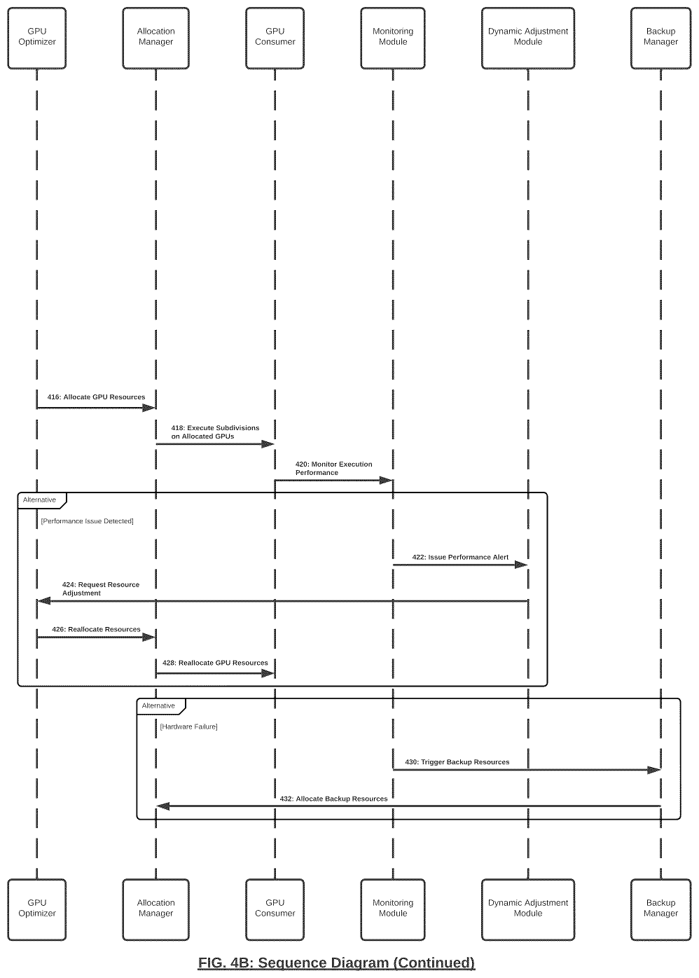

FIG. 4A and FIG. 4B present sequence diagrams that illustrate the detailed interactions between the core components of the system as they work together to optimize the selection and use of GPU resources in real-time for executing computational programs. These diagrams depict the flow of messages and actions between the different components, starting from when the user submits a program through to its execution, real-time monitoring, dynamic adjustments, and eventual completion. The diagrams highlight how each module in the system plays a role in processing the program, managing resources, and ensuring efficient execution.

In FIG. 4A, the sequence begins when the user submits a computational program to the system at step 400. The program is transmitted to the program analyzer, which is tasked with breaking down the program into multiple subdivisions. This initial step is essential for allowing the system to manage each subdivision independently based on its unique computational requirements. The program analyzer processes the incoming program and generates smaller computational tasks, each of which can be handled by different GPU resources. These tasks could involve operations such as matrix multiplications, vector processing, or Fast Fourier Transformations (FFT). Once the subdivisions have been created, they are sent to the GPU resource matcher at step 402.

At step 402, the GPU resource matcher receives the program subdivisions and evaluates the computational needs of each one. Its purpose is to determine which GPU is most suitable for handling each task. To achieve this, the GPU resource matcher examines the architecture of available GPUs, considering factors such as the number of cores, memory bandwidth, clock speed, and other hardware attributes. Each subdivision has specific computational requirements, and the matcher ensures that it is paired with the GPU that can perform the task most efficiently. By selecting the most appropriate GPU, the system maximizes performance while minimizing execution time and resource waste.

Once the GPU resource matcher has matched the subdivisions to suitable GPUs, the system moves to step 404, where the time predictor becomes involved. The time predictor forecasts when each subdivision will require access to GPU resources and for how long those resources will be needed. This step is for ensuring that the necessary GPU resources are available at the correct time during program execution. The time predictor uses historical data, previous execution metrics, and real-time performance information to predict the duration and timing of GPU needs. These accurate predictions prevent the program from stalling due to a lack of resources and ensure that GPUs are reserved for the appropriate length of time, optimizing resource utilization.

At step 406, the GPU resource locator receives information from the time predictor about the predicted resource needs and timing. The GPU resource locator is responsible for finding available GPUs that meet the program's specific requirements. It interacts with a dynamic marketplace that offers GPU resources from a variety of sources, including cloud providers, private networks, and independent GPU owners. The GPU resource locator queries the marketplace to identify GPUs that match the computational needs of the subdivisions and that will be available during the predicted time windows. This component plays a key role in expanding the pool of available resources, allowing the system to dynamically acquire additional GPUs as necessary.

After identifying the available GPU resources, the system moves to step 408, where the GPU optimizer takes over. The GPU optimizer receives the list of available GPUs from the GPU resource locator and assesses each one based on various factors, including cost, power consumption, and environmental impact (such as carbon footprint). This step helps ensure that the selected GPUs not only meet the computational requirements but also provide the best balance of cost and efficiency. The GPU optimizer makes trade-offs between performance and cost to select the optimal GPU for each subdivision. By considering the total cost of GPU usage, the optimizer reduces the overall expense of executing the program while maintaining high performance.

At step 410, the GPU optimizer sends the allocation plan to the allocation manager. The allocation manager is responsible for assigning the selected GPUs to the appropriate program subdivisions. It ensures that each subdivision receives the correct GPU resources based on the optimization carried out by the GPU optimizer. The allocation manager ensures that resource allocation is efficient and that there are no conflicts or delays in execution. This step is for preparing the program to proceed toward execution, ensuring that each task has the necessary resources to be executed smoothly.

The process in FIG. 4A concludes at step 412, where the GPU consumer begins the execution of the program. The GPU consumer initiates the actual running of each program subdivision on the assigned GPUs. This component oversees the execution phase, ensuring that each subdivision is processed using the GPU resources that have been allocated to it. During this phase, the GPU consumer collects data on performance and resource utilization, which is used to monitor and optimize the ongoing execution of the program. This real-time execution data is for ensuring that the program runs efficiently and that resources are being used effectively.

The sequence continues in FIG. 4B, where the focus shifts to real-time monitoring and dynamic adjustments during program execution. At step 414, the monitoring module begins tracking the performance of the GPUs and the progress of the program as it runs. The monitoring module constantly monitors the health of the GPUs, checking for issues such as overheating, underperformance, or hardware failure. This real-time monitoring is essential for detecting problems early, allowing the system to respond quickly and maintain optimal performance. If any issues are detected, the monitoring module sends an alert to the dynamic adjustment module at step 416.

At step 416, the dynamic adjustment module receives the alert from the monitoring module and takes action to resolve the issue. The dynamic adjustment module is responsible for making real-time changes to the GPU resource allocation in response to performance issues or resource availability problems. For instance, if a GPU fails or starts underperforming, the dynamic adjustment module reallocates resources to ensure that the program continues running without interruption. This dynamic capability allows the system to adapt to changing conditions in real-time, ensuring that program execution is not delayed or negatively impacted by resource constraints.

If a more serious issue arises, such as a complete GPU failure, the backup manager is activated at step 420. The backup manager manages additional GPU resources that have been reserved as backups in case of hardware failure. If a primary GPU becomes unavailable, the backup manager steps in to allocate the backup GPU resources to the affected program subdivisions. This step ensures that the program continues running even if one or more GPUs fail. By incorporating backup resources, the system enhances its reliability and ensures that programs can be executed without interruption, even in the face of unexpected hardware issues.

Meanwhile, the cost prediction module at step 422 continuously evaluates pricing trends in the GPU marketplace. This module analyzes historical pricing data and predicts future fluctuations in GPU prices. By forecasting future price changes, the cost prediction module enables the system to make informed decisions about when to acquire additional GPU resources. This proactive cost management allows the system to minimize costs by acquiring resources at optimal prices while still meeting the program's performance requirements. The cost prediction module plays a role in optimizing resource usage and reducing the total cost of executing the program.

Finally, the sequence diagram in FIG. 4B concludes at step 424, where the GPU consumer completes the execution of the program. Once all program subdivisions have been processed on the allocated GPUs, the GPU consumer notifies the user that the program has been successfully executed. This final step confirms that the program has been completed efficiently, with minimal delays and at the lowest possible cost. The system ensures that all resources have been used effectively, and any necessary adjustments have been made to ensure the program's successful execution.

In summary, FIG. 4A and FIG. 4B provide a detailed and comprehensive view of the interactions between the system's components as they work together to manage and optimize the execution of a computational program. In FIG. 4A, the sequence begins with the submission of the program, followed by the steps of program subdivision, GPU matching, time prediction, resource location, and optimization. The program analyzer, GPU resource matcher, time predictor, GPU resource locator, GPU optimizer, and allocation manager ensure that the correct GPU resources are identified, allocated, and prepared for execution. In FIG. 4B, the focus shifts to real-time execution, monitoring, and dynamic adjustments. The monitoring module, dynamic adjustment module, and backup manager ensure that execution proceeds smoothly, addressing any performance or hardware issues that arise during the process. Finally, the cost prediction module optimizes resource usage by predicting future pricing trends, and the GPU consumer completes the program execution, ensuring an efficient and reliable outcome.

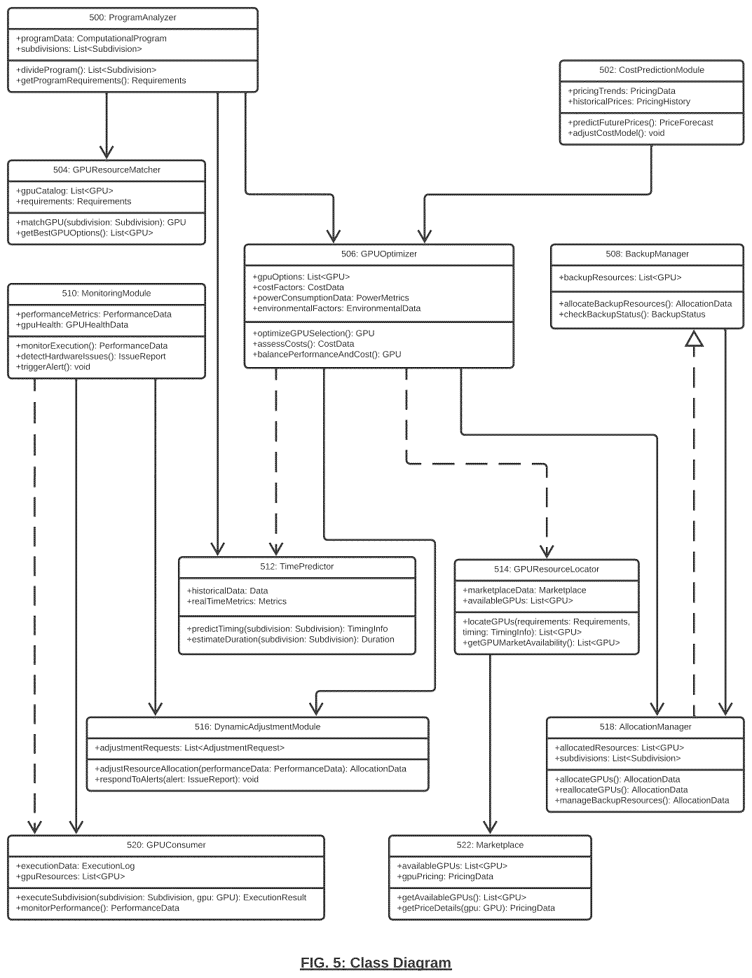

FIG. 5 presents a class diagram that illustrates the structure of the core components of the system, highlighting the relationships between these components and their respective attributes and methods. The diagram shows how each component functions as a class, encapsulating specific responsibilities within the overall architecture. This class diagram provides a detailed representation of the system's modular design, showing how various classes interact and contribute to the system's ability to optimize GPU resource selection and usage for executing computational programs. Each class in the diagram is labeled with a specific number, which corresponds to its role in the system's operation.

Class 502 represents the ProgramAnalyzer class, which plays a central role in the system's operation. The ProgramAnalyzer is responsible for taking the computational program submitted by the user and breaking it down into smaller, more manageable subdivisions. This class contains key attributes such as programData and subdivisions, which represent the input program and the individual components that result from the analysis. The methods within the ProgramAnalyzer, including divideProgram( ) and getProgramRequirements( ) are essential for processing the program and dividing it into computational tasks based on the specific requirements of each part of the program. By generating these subdivisions, the ProgramAnalyzer enables the system to manage each computational task separately, allowing for optimized resource allocation and execution.

Class 504 is the GPUResourceMatcher class, which is directly connected to the ProgramAnalyzer. The GPUResourceMatcher is responsible for determining which GPU is most suitable for each subdivision of the program. This class has important attributes such as gpuCatalog and requirements, which hold information about the available GPUs in the system and the specific needs of the program's subdivisions. The methods in the GPUResourceMatcher, such as matchGPU(subdivision) and getBestGPUOptions( ) are used to evaluate the computational requirements of each subdivision and select the most appropriate GPU from the available options. This matching process is for optimizing the performance of the program because it ensures that each task is handled by the GPU that can process it most efficiently. The goal of the GPUResourceMatcher is to pair each subdivision with the GPU that best fits its computational needs, thereby minimizing execution time and maximizing system efficiency.

Class 506, labeled as TimePredictor, is responsible for forecasting when each subdivision will require GPU resources and for how long those resources will be needed. The TimePredictor class includes key attributes such as historicalData and realTimeMetrics, which store data from previous program executions as well as current performance metrics. The methods in the TimePredictor, such as predictTiming(subdivision) and estimateDuration(subdivision), are essential for generating accurate predictions about when GPU resources will be required. These predictions allow the system to allocate GPU resources more effectively by ensuring that resources are available at the right time during the program's execution. By leveraging historical data and real-time metrics, the TimePredictor helps prevent resource bottlenecks and ensures that GPU resources are reserved ahead of time, reducing delays and improving overall execution efficiency.

Class 508 is the GPUResourceLocator class, which interacts with the TimePredictor and other components to find GPUs in the marketplace that meet the specific needs of the program's subdivisions. The GPUResourceLocator contains attributes such as marketplaceData and availableGPUs, which store information about the GPUs that are currently available in the marketplace. The methods in this class, including locateGPUs(requirements, timing) and getGPUMarketAvailability( ) are responsible for identifying available GPUs that match the computational needs and timing predicted by the TimePredictor. This component plays a vital role in the system's ability to dynamically acquire additional resources, as it interfaces with the GPU marketplace to find the best GPUs available at any given time.

Class 510 is the GPUOptimizer class, which is responsible for evaluating and selecting the optimal GPUs for each subdivision of the program. This class has attributes such as gpuOptions, costFactors, powerConsumptionData, and environmentalFactors, which store important information related to the available GPUs, their costs, energy efficiency, and environmental impact. The methods in this class, such as optimizeGPUSelection( ) and balancePerformanceAndCost( ) are used to assess the trade-offs between performance and cost when selecting GPUs. The GPUOptimizer ensures that the GPUs chosen for each subdivision provide the best balance of performance, cost-effectiveness, and energy efficiency. By carefully considering factors such as power consumption and environmental impact, the GPUOptimizer helps the system select GPUs that minimize operational costs while still meeting the program's computational requirements.

Class 512 represents the AllocationManager class, which is responsible for assigning the selected GPUs to the appropriate subdivisions of the program. The AllocationManager has attributes such as allocatedResources and subdivisions, which keep track of which GPUs have been assigned to each task. The methods within the AllocationManager, such as allocateGPUs( ) and reallocateGPUs( ) manage the distribution of GPU resources during program execution. This class ensures that each subdivision receives the GPU resources it needs and that any changes in resource availability are handled smoothly. The AllocationManager plays a key role in ensuring that resources are used efficiently and that the program can be executed without delays or interruptions.

Class 514 is the GPUConsumer class, which handles the actual execution of the program subdivisions on the allocated GPUs. The GPUConsumer includes attributes such as executionData and gpuResources, which store information about the progress of the program's execution and the GPUs being used. The methods in this class, including executeSubdivision (subdivision, gpu) and monitorPerformance( ) are responsible for running each subdivision on the allocated GPU and collecting performance data throughout the execution process. The GPUConsumer ensures that the program runs as planned and that any issues that arise during execution are addressed promptly.

Class 516 is the MonitoringModule class, which continuously tracks the performance of the GPUs during program execution. The MonitoringModule has attributes such as performanceMetrics and gpuHealth, which store data on the current performance of the GPUs and their operational health. The methods in this class, including monitorExecution( ) and detectHardwareIssues( ) are used to identify any problems, such as overheating or hardware failure, that could impact the performance of the program. The MonitoringModule provides real-time monitoring of GPU resources, ensuring that any issues are quickly detected and addressed.

Class 518, the DynamicAdjustmentModule, interacts closely with the MonitoringModule to make real-time adjustments to GPU resource allocation. This class includes attributes such as adjustmentRequests and methods such as adjustResourceAllocation(performanceData) and respondToAlerts(alert). When the MonitoringModule detects performance issues, the DynamicAdjustmentModule reallocates resources or adjusts the execution plan to ensure that the program continues running smoothly. This ability to make dynamic adjustments in real-time is for maintaining system flexibility and ensuring that program execution is not disrupted by resource shortages or hardware failures.

Class 520, the BackupManager, is responsible for managing backup GPU resources in the event of hardware failures or resource unavailability. The BackupManager contains attributes such as backupResources, which track the available backup GPUs, and methods such as allocateBackupResources( ) and checkBackupStatus( ) The BackupManager ensures that additional resources are available when needed, allowing the system to continue executing the program even if primary GPU resources fail. This component provides an additional layer of reliability to the system by ensuring that programs can continue running without interruption.

Class 522 is the Marketplace class, which represents the external marketplace where GPU resources are rented or purchased. The Marketplace has attributes such as availableGPUs and gpuPricing, which store information about the GPUs that are currently available for use and their associated costs. The methods within this class, such as getAvailableGPUs( ) and getPriceDetails(gpu), allow the system to access real-time data on available GPUs and their prices, enabling the system to acquire the resources needed for program execution.

Class 524 represents the CostPredictionModule, which is responsible for predicting future GPU prices and helping the system optimize resource usage. This class includes attributes such as pricingTrends and historicalPrices, which store data on past pricing and market trends, and methods such as predictFuturePrices( ) and adjustCostModel( ). The CostPredictionModule helps the system make informed decisions about when to acquire GPU resources by predicting fluctuations in prices and identifying opportunities to minimize costs.

In summary, FIG. 5 illustrates how the system's components function as individual classes, each with its own attributes and methods. The ProgramAnalyzer (class 502), GPUResourceMatcher (class 504), TimePredictor (class 506), GPUResourceLocator (class 508), GPUOptimizer (class 510), AllocationManager (class 512), GPUConsumer (class 514), MonitoringModule (class 516), DynamicAdjustmentModule (class 518), BackupManager (class 520), Marketplace (class 522), and CostPredictionModule (class 524) work together to ensure the efficient execution of computational programs by optimizing GPU resource selection, allocation, and usage. Each class in this diagram plays a distinct role in the system's overall operation, contributing to the flexibility, scalability, and cost-effectiveness of the solution. The class diagram demonstrates how these components are modular, allowing the system to adapt to different computational tasks and environments while ensuring optimal performance.

Sample pseudocode to implement the various aspects of the invention corresponds to the functions represented in the class diagram, providing a comprehensive flow of how each component interacts to optimize the selection and usage of GPU resources in real-time for executing computational programs. Below is the pseudocode implementation for each class and its functions, followed by a detailed explanation of how the pseudocode operates within the context of the invention.

```
// Class: ProgramAnalyzer
class ProgramAnalyzer:
  attributes:
    programData: ComputationalProgram
    subdivisions: List<Subdivision>
  function divideProgram(programData):
    // Divide the program into subdivisions based on computational requirements
    subdivisions = [ ]
    for task in programData:
      subdivision = createSubdivision(task)
      subdivisions.append(subdivision)
    return subdivisions
  function getProgramRequirements(subdivisions):
    // Analyze the requirements for each subdivision
    requirements = [ ]
    for subdivision in subdivisions:
      requirement = analyzeTask(subdivision)
      requirements.append(requirement)
    return requirements
// Class: GPUResourceMatcher
class GPUResourceMatcher:
  attributes:
    gpuCatalog: List<GPU>
    requirements: List<Requirement>
  function matchGPU(subdivision, gpuCatalog):
    // Match each subdivision to the most suitable GPU
    suitableGPU = None
    for gpu in gpuCatalog:
      if gpu.meetsRequirements(subdivision.requirements):
        suitableGPU = gpu
        break
    return suitableGPU
  function getBestGPUOptions(gpuCatalog):
    // Return a list of optimal GPUs based on the system's requirements
    optimalGPUs = [ ]
    for gpu in gpuCatalog:
      if gpu.isOptimal( ):
        optimalGPUs.append(gpu)
    return optimalGPUs
// Class: TimePredictor
class TimePredictor:
  attributes:
    historicalData: Data
    realTimeMetrics: Metrics
  function predictTiming(subdivision):
    // Predict when each subdivision will require GPU resources
    timing = calculateTiming(historicalData, realTimeMetrics, subdivision)
    return timing
  function estimateDuration(subdivision):
    // Estimate how long the GPU resources will be required
    duration = calculateDuration(subdivision)
    return duration
// Class: GPUResourceLocator
class GPUResourceLocator:
  attributes:
    marketplaceData: Marketplace
    availableGPUs: List<GPU>
  function locateGPUs(requirements, timing):
    // Locate GPUs in the marketplace based on the requirements and timing
    locatedGPUs = [ ]
    for gpu in marketplaceData:
      if gpu.isAvailableAt(timing) and gpu.meetsRequirements(requirements):
        locatedGPUs.append(gpu)
    return locatedGPUs
  function getGPUMarketAvailability( ):
    // Return a list of available GPUs in the marketplace
    return marketplaceData.getAvailableGPUs( )
// Class: GPUOptimizer
class GPUOptimizer:
  attributes:
    gpuOptions: List<GPU>
    costFactors: CostData
    powerConsumptionData: PowerMetrics
    environmentalFactors: EnvironmentalData
  function optimizeGPUSelection(gpuOptions, costFactors, powerConsumptionData,
environmentalFactors):
    // Optimize GPU selection based on performance, cost, power consumption, and
environmental impact
    bestGPU = None
    bestCost = float(‘inf’)
    for gpu in gpuOptions:
      totalCost = calculateCost(gpu, costFactors, powerConsumptionData,
environmentalFactors)
      if totalCost < bestCost:
        bestGPU = gpu
        bestCost = totalCost
    return bestGPU
  function balancePerformanceAndCost( ):
    // Balance performance and cost across available GPUs
    performanceToCostRatio = [ ]
    for gpu in gpuOptions:
      ratio = calculatePerformanceCostRatio(gpu)
      performanceToCostRatio.append((gpu, ratio))
    return sortByRatio(performanceToCostRatio)
// Class: AllocationManager
class AllocationManager:
  attributes:
    allocatedResources: List<GPU>
    subdivisions: List<Subdivision>
  function allocateGPUs(subdivisions, gpuOptions):
    // Allocate GPUs to the subdivisions
    for subdivision in subdivisions:
      suitableGPU = GPUOptimizer.optimizeGPUSelection(gpuOptions)
      allocatedResources.append(suitableGPU)
    return allocatedResources
  function reallocateGPUs( ):
    // Reallocate GPU resources if needed
    for resource in allocatedResources:
      if resource.isUnderperforming( ):
        newResource = GPUResourceLocator.locateGPUs(requirements, timing)
        replaceResource(resource, newResource)
// Class: GPUConsumer
class GPUConsumer:
  attributes:
    executionData: ExecutionLog
    gpuResources: List<GPU>
  function executeSubdivision(subdivision, gpu):
    // Execute the program subdivision on the allocated GPU
    result = gpu.execute(subdivision)
    executionData.log(result)
    return result
  function monitorPerformance( ):
    // Monitor performance data during execution
    for gpu in gpuResources:
      performanceData = gpu.getPerformanceMetrics( )
      executionData.log(performanceData)
// Class: MonitoringModule
class MonitoringModule:
  attributes:
    performanceMetrics: PerformanceData
    gpuHealth: GPUHealthData
  function monitorExecution(gpuResources):
    // Monitor GPU performance in real-time
    for gpu in gpuResources:
      metrics = gpu.checkPerformance( )
      performanceMetrics.update(metrics)
      if gpu.isFailing( ):
        detectHardwareIssues(gpu)
  function detectHardwareIssues(gpu):
    // Detect hardware failures and alert the system
    if gpu.isOverheating( ) or gpu.isFaulty( ):
      alertSystem(gpu)
// Class: DynamicAdjustmentModule
class DynamicAdjustmentModule:
  attributes:
    adjustmentRequests: List<AdjustmentRequest>
  function adjustResourceAllocation(performanceData):
    // Dynamically adjust GPU allocation based on performance
    for request in adjustmentRequests:
      if performanceData.isDeclining( ):
        adjustResources(request)
  function respondToAlerts(alert):
    // Respond to alerts from the MonitoringModule
    if alert.isCritical( ):
      reallocateResources(alert)
// Class: BackupManager
class BackupManager:
  attributes:
    backupResources: List<GPU>
  function allocateBackupResources( ):
    // Allocate backup GPU resources in case of failure
    for resource in backupResources:
      if resource.isAvailable( ):
        return resource
  function checkBackupStatus( ):
    // Check the status of backup resources
    for backup in backupResources:
      if backup.isAvailable( ):
        return True
      else:
        return False
// Class: Marketplace
class Marketplace:
  attributes:
    availableGPUs: List<GPU>
    gpuPricing: PricingData
  function getAvailableGPUs( ):
    // Return the list of available GPUs in the marketplace
    return availableGPUs
  function getPriceDetails(gpu):
    // Get pricing details for a specific GPU
    return gpuPricing.getPrice(gpu)
// Class: CostPredictionModule
class CostPredictionModule:
  attributes:
    pricingTrends: PricingData
    historicalPrices: PricingHistory
  function predictFuturePrices( ):
    // Predict future GPU prices based on historical data
    return pricingTrends.analyze(historicalPrices)
  function adjustCostModel( ):
    // Adjust cost models based on predicted prices
    pricingTrends.updateModel( )
```

The pseudocode begins with the ProgramAnalyzer class, responsible for analyzing the computational program submitted by the user. The divideProgram function splits the program into subdivisions based on its specific computational tasks. These subdivisions are essential for breaking the program into smaller tasks that can be allocated to different GPUs. The getProgramRequirements function further analyzes each subdivision to determine its unique requirements, which will later be used by the GPUResourceMatcher class.

The GPUResourceMatcher class handles the process of identifying the most appropriate GPU for each program subdivision. The matchGPU function evaluates the available GPUs against the requirements of each subdivision and selects the best match based on factors like core count, memory bandwidth, and architecture. The getBestGPUOptions function returns a list of optimal GPUs from the system's catalog based on their performance attributes.

The TimePredictor class then forecasts when each subdivision will require GPU resources. The predictTiming function uses historical data and real-time metrics to make accurate predictions about resource timing, while estimateDuration provides an estimate of how long the resources will be needed for each subdivision. This timing information is for ensuring that GPU resources are reserved and available when required.

Next, the GPUResourceLocator class locates available GPUs in the marketplace. The locateGPUs function queries the marketplace to find GPUs that meet the predicted timing and requirements of the program subdivisions. The system ensures that the GPUs are available for the predicted duration. The function getGPUMarketAvailability returns a real-time list of GPUs available in the marketplace.

The GPUOptimizer class is responsible for optimizing the selection of GPUs based on factors like performance, cost, power consumption, and environmental impact. The optimizeGPUSelection function identifies the best GPU by calculating the total cost and balancing it against performance and other factors. The balancePerformanceAndCost function further optimizes the system by calculating the performance-to-cost ratio of each GPU, allowing the system to choose the best resources while maintaining cost efficiency.

Once the GPUs have been optimized, the AllocationManager allocates these GPUs to the program subdivisions using the allocateGPUs function. This function assigns resources based on the optimization performed by the GPUOptimizer, ensuring that each task has the most suitable GPU. If any issues arise during execution, the reallocateGPUs function reallocates resources dynamically, helping to avoid delays or underperformance.

The GPUConsumer class oversees the execution of the program subdivisions on the allocated GPUs. The executeSubdivision function manages the actual running of each task on the GPU, while the monitorPerformance function collects real-time data on GPU performance and logs it for later analysis.

The MonitoringModule continuously tracks GPU health and performance through its monitorExecution function, checking for hardware issues or performance bottlenecks. If any issues are detected, the detectHardwareIssues function sends an alert to the system to resolve the problem.

The DynamicAdjustmentModule works closely with the MonitoringModule to dynamically adjust GPU resource allocation if performance declines. The adjustResourceAllocation function reallocates resources as needed, while respondToAlerts ensures that any critical hardware failures or performance issues are addressed promptly.

The BackupManager is responsible for managing backup GPU resources in the event of a hardware failure. The allocateBackupResources function assigns backup GPUs to ensure program execution continues smoothly, while checkBackupStatus ensures that backup resources are available and ready to be deployed.

Finally, the Marketplace class interacts with external GPU providers to acquire resources. The getAvailableGPUs function returns a list of currently available GPUs, and the getPriceDetails function provides pricing information for each resource. The CostPredictionModule uses this data to predict future GPU prices, adjusting the system's cost model accordingly to minimize expenses.

This pseudocode demonstrates sample operation of the system, from program analysis and GPU matching to real-time monitoring, dynamic adjustments, and cost optimization. Each class works together to ensure that computational programs are executed efficiently and at the lowest possible cost, while maintaining system flexibility and reliability.

A skilled artisan, upon reviewing the disclosure, will appreciate that there are numerous alternatives, modifications, combinations, and customizations that can be made to the systems and methods described herein.

The systems and methods of the invention can be modified, customized, and adapted in a variety of ways to suit different use cases, performance requirements, and technological environments. These alternatives, modifications, combinations, and customizations offer flexibility and scalability, allowing the system to meet specific needs while maintaining core functionalities. These alternatives and modifications cover various components, from how programs are subdivided to how GPU resources are matched, predicted, and optimized.

One area for modification lies in the ProgramAnalyzer. While the default configuration divides a program based on specific computational requirements such as matrix multiplications or vector operations, alternative approaches could involve dividing the program based on workload type, input size, or data dependencies. For example, in some implementations, the program could be divided dynamically based on real-time profiling rather than static analysis. This would allow for more adaptive subdivision, especially in applications where the computational complexity changes during execution.

The GPUResourceMatcher can also be customized depending on the available hardware or the needs of a specific application. In some alternatives, the matcher could be enhanced to consider additional factors such as network latency or proximity to the data source, especially in distributed systems. Furthermore, the system could employ more sophisticated matching algorithms such as machine learning-based models that predict the most suitable GPU for each task based on historical execution data. This could replace the simpler comparison of hardware attributes currently used by the matcher.

For the TimePredictor, alternatives could involve integrating more advanced prediction models. Instead of using only historical data and real-time metrics, the time predictor could be enhanced with machine learning algorithms capable of identifying complex patterns in execution times and forecasting more accurately when GPU resources will be needed. Additionally, modifications could allow the time predictor to adjust its predictions dynamically based on changing workload conditions, such as fluctuating network bandwidth or varying system loads.

The GPUResourceLocator could be modified to search for resources across multiple, decentralized marketplaces. In some scenarios, a decentralized marketplace leveraging blockchain or distributed ledger technology could be used to enhance security and transparency. The locator could also be extended to search for resources in hybrid environments, combining both on-premises GPU clusters with cloud-based resources. Moreover, customizations could enable the system to prioritize GPUs that are part of green computing initiatives, reducing the system's overall carbon footprint by favoring energy-efficient hardware.

Customizations of the GPUOptimizer could allow for more detailed cost analysis and environmental impact evaluations. For example, in some implementations, the system could incorporate real-time energy pricing data to optimize GPU selection not just on hardware cost but also on fluctuating energy rates. In addition, the optimization could include an environmental score that considers factors such as carbon emissions, making the system more suitable for applications where sustainability is a key concern.

Another area for potential customization is the AllocationManager. Instead of static allocation, more dynamic resource management schemes could be applied. For example, GPU resources could be over-allocated during critical phases of execution, followed by under-allocation in less intensive phases, optimizing resource use across the program lifecycle. The allocation manager could also be modified to allow for more granular control over resource allocation, such as reserving a pool of GPUs exclusively for high-priority tasks, while other tasks are handled with lower-priority resources.

In the GPUConsumer, alternatives might include the ability to split the execution of subdivisions across multiple GPUs, effectively allowing for parallelization within each subdivision. This would be particularly useful in scenarios where a single GPU is insufficient for handling a computationally heavy task. Additionally, the system could incorporate fault-tolerance mechanisms where the GPUConsumer automatically retries execution on a different GPU if a hardware failure is detected during the initial execution.

The MonitoringModule can also be customized to incorporate more advanced diagnostic tools. For example, in some alternatives, the monitoring could include predictive maintenance features that anticipate GPU failure before it occurs, based on patterns of degradation observed in hardware metrics. Furthermore, more granular monitoring could be implemented to track GPU thermal activity, memory usage, and other real-time metrics at a finer level of detail, allowing the system to respond to issues before they escalate into critical problems.

The DynamicAdjustmentModule could be modified to enable proactive rather than reactive adjustments. For example, instead of waiting for a performance issue to occur, the module could continuously predict potential bottlenecks and make adjustments preemptively. This would allow the system to maintain peak performance under changing conditions. Another alternative is to integrate a learning-based system that improves the accuracy of adjustments over time based on previous execution data.

In the case of the BackupManager, one alternative involves implementing a more hierarchical system for managing backup resources. Instead of simply having a pool of backup GPUs, the system could be modified to manage multiple tiers of backup resources, where the first tier is comprised of on-premise backups, and the second tier includes external or cloud-based GPUs. This would allow for quicker failover in the case of a local resource failure and ensure that critical tasks are not interrupted.

For the Marketplace, alternatives include the integration of more sophisticated bidding mechanisms. In some scenarios, users could bid for GPU resources in real-time, allowing the system to select GPUs based on the best price-performance ratio. Another alternative is the use of smart contracts, where the acquisition of GPU resources is automated through blockchain-based contracts that execute as soon as certain conditions are met, such as a GPU becoming available at a certain price.

The CostPredictionModule can also be enhanced by incorporating more complex pricing models. For example, instead of relying solely on historical pricing data, the system could pull in real-time market analytics from external sources, adjusting predictions based on fluctuating demand or economic trends. Additionally, the module could be customized to factor in long-term contracts or GPU leases, where the cost model accounts for bulk discounts or long-term pricing agreements.

Combinations of these alternatives can further enhance the system's flexibility. For instance, a combination of dynamic time prediction, decentralized marketplaces, and fault-tolerant execution could create a highly adaptable system capable of scaling up or down depending on the computational load and availability of GPU resources. Similarly, integrating machine learning-based prediction models with proactive dynamic adjustments would result in a highly efficient system that continuously learns from its execution history to optimize future performance.

Moreover, the system can be customized for specific industries or applications. For example, in a setting where real-time imaging is required, the system could be adapted to prioritize low-latency GPUs that minimize processing time, while in a research environment, the system might prioritize GPUs that offer the best balance between cost and computational power for running complex simulations. In autonomous driving applications, the system could be customized to ensure high availability and fault tolerance, as real-time decisions are critical to ensuring safety.

The system's adaptability can also extend to varying hardware environments. It could be customized to handle alternative processing units, such as TPUs (Tensor Processing Units) or FPGAs (Field-Programmable Gate Arrays), for specific types of computational tasks, such as AI inference or low-latency edge computing. The modularity of the system would allow these alternative processing units to be integrated with minimal changes to the overall architecture.

In conclusion, numerous alternatives, modifications, combinations, and customizations can be made to the system and methods of the invention. From modifying the way programs are analyzed and subdivided, to customizing how resources are matched, predicted, and optimized, the system offers significant flexibility. Integration of decentralized marketplaces, advanced machine learning models, proactive adjustment mechanisms, hierarchical backup management, and specialized hardware all offer opportunities to tailor the system to different industries, application domains, and performance goals. These changes allow the invention to be highly adaptable to a wide range of technological environments, ensuring it remains useful and efficient in diverse contexts.

Although the present technology has been described based on what is currently considered the most practical and preferred implementations, it is to be understood that this detail is only for that purpose and this disclosure is not limited to the sample descriptions and implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A method for optimizing selection and use of GPU resources in real-time for executing a computational program, comprising the steps of:
dividing, by a program analyzer, the computational program into subdivisions based on specific computational requirements of each part of the computational program;
determining, by a GPU resource matcher, a suitable type of GPU for each of said subdivisions of the computational program based on subdivision computational requirements;
predicting, by a time predictor, when said subdivisions of the computational program will require GPU resources and duration of that need;
locating, by a GPU resource locator, available GPU resources in a marketplace, wherein the locating includes identifying GPUs that meet the subdivision computational requirements and will be available at the predicted time, and the locating is performed;
assessing, by a GPU optimizer, a cost of the located GPU resources for the predicted time and determining a most cost-effective GPU resource to use for each of the subdivisions,
allocating, by the GPU optimizer, selected GPU resources for said subdivisions of the computational program based on suitability and cost-effectiveness;
executing, by a GPU consumer, said subdivisions of the computational program on the GPU resources as allocated;
monitoring, by the GPU consumer, the execution of each subdivision in real-time to ensure that the GPU resources are being used efficiently and updating predicted time requirements if necessary; and
adjusting, by the GPU optimizer, the allocation of the GPU resources dynamically during the execution of the computational program in response to changes in resource availability or execution performance.

2. The method of claim 1, wherein the program analyzer divides the computational program based on predefined types of computations, including but not limited to vector operations, matrix multiplications, Fast Fourier Transformations (FFT), and inverse FFTs.

3. The method of claim 2, wherein the GPU resource matcher further selects a suitable GPU based on specific hardware architecture of the GPU, including a number of cores, memory bandwidth, and clock speed.

4. The method of claim 3, wherein the time predictor estimates the required duration of GPU resources based on historical data of similar computational tasks and real-time performance metrics.

5. The method of claim 4, wherein the GPU resource locator further identifies GPUs that are available across multiple platforms, including cloud-based providers and private networks.

6. The method of claim 5, wherein the marketplace includes an auction-based system where GPU providers offer resources at dynamically adjusted prices based on demand and availability.

7. The method of claim 6, wherein the GPU optimizer prioritizes the selection of GPUs that have the lowest power consumption while still meeting the computational requirements of the program subdivisions.

8. The method of claim 7, wherein the GPU optimizer further considers a carbon footprint of a GPU provider's data center as a factor in selecting the most cost-effective GPU resource.

9. The method of claim 8, wherein the allocation of GPUs is dynamically adjusted during the execution of the program based on real-time updates from the GPU consumer regarding performance and resource availability.

10. The method of claim 9, wherein the GPU consumer continuously monitors GPU utilization and updates a predicted completion time for each subdivision based on the actual performance of the GPUs.

11. The method of claim 10, wherein the GPU consumer issues alerts to the GPU optimizer if a subdivision's execution is falling behind schedule, allowing for adjustments to resource allocation.

12. The method of claim 11, wherein the GPU optimizer can reallocate unused or underutilized GPU resources from other programs within the marketplace to the current program to prevent delays in execution.

13. The method of claim 12, wherein the GPU consumer evaluates health of the allocated GPUs, checking for overheating, underperformance, or hardware failure, and reports status to the GPU optimizer.

14. The method of claim 13, wherein the system further includes a fallback mechanism, wherein the GPU optimizer can reserve backup GPUs in event of hardware failure or unavailability during program execution.

15. The method of claim 14, wherein the GPU optimizer adjusts the cost model dynamically, considering fluctuations in marketplace prices for GPU resources over the duration of the program execution.

16. The method of claim 15, wherein the GPU optimizer implements a cost-prediction model that estimates future GPU prices based on current trends and historical pricing data from the marketplace.

17. The method of claim 16, wherein the marketplace includes the ability for users to rent out excess GPU resources to other users in real time, allowing for dynamic role-switching between GPU consumer and GPU provider.

18. The method of claim 17, wherein the program analyzer further optimizes the subdivisions of the program to minimize memory transfer bottlenecks between a CPU and the GPU during execution.

19. A method for optimizing selection and use of GPU resources in real-time for executing a computational program, comprising the steps of:
dividing, by a program analyzer, the computational program into subdivisions based on specific computational requirements of each part of the computational program, wherein the dividing is based on predefined types of computations, including but not limited to vector operations, matrix multiplications, Fast Fourier Transformations (FFT), and inverse FFTs;
determining, by a GPU resource matcher, a suitable type of GPU for each of said subdivisions of the computational program based on subdivision computational requirements, wherein the GPU resource matcher further selects the GPU based on hardware architecture, including a number of cores, memory bandwidth, and clock speed of the GPUs;
predicting, by a time predictor, when said subdivisions of the computational program will require GPU resources and duration of that need, wherein the time predictor estimates duration based on historical data of similar computational tasks and real-time performance metrics;
locating, by a GPU resource locator, available GPU resources in a marketplace, wherein the locating includes identifying GPUs that meet the subdivision computational requirements and will be available at the predicted time, and wherein the marketplace includes cloud-based providers, private networks, and an auction-based system where GPU resources are offered at dynamically adjusted prices based on demand and availability;
assessing, by a GPU optimizer, a cost of the located GPU resources for the predicted time, wherein the GPU optimizer prioritizes the selection of GPUs that have the lowest power consumption while meeting computational requirements, and further considers a carbon footprint of a data center hosting the GPUs;
allocating, by the GPU optimizer, selected GPU resources for said subdivisions of the computational program based on suitability, cost-effectiveness, power consumption, and carbon footprint, wherein the allocation is dynamically adjusted during execution based on real-time updates from a GPU consumer;
executing, by the GPU consumer, said subdivisions of the computational program on the allocated GPU resources, wherein the GPU consumer monitors GPU utilization in real-time and updates a predicted completion time for each subdivision based on actual performance;
monitoring, by the GPU consumer, the execution of each subdivision in real-time to ensure efficient GPU usage, wherein the GPU consumer evaluates GPU health, including monitoring for overheating, underperformance, or hardware failure, and reports status to the GPU optimizer;
adjusting, by the GPU optimizer, the allocation of the GPU resources dynamically during the execution of the computational program in response to changes in resource availability, execution performance, or detected hardware issues, wherein unused or underutilized GPU resources are reallocated as needed;
reserving, by the GPU optimizer, backup GPU resources in event of hardware failure or unavailability during program execution, ensuring uninterrupted performance of the computational program;
implementing, by the GPU optimizer, a dynamic cost-prediction model that estimates future GPU prices based on marketplace trends and historical pricing data, and adjusting the cost model in real-time to account for fluctuations in GPU pricing;
enabling, by the marketplace, users to rent out excess GPU resources in real time, allowing dynamic role-switching between GPU consumer and GPU provider; and
optimizing, by the program analyzer, the subdivisions of the computational program to minimize memory transfer bottlenecks between a CPU and GPU during execution.

20. A system for optimizing selection and use of GPU resources in real-time for executing a computational program, comprising:
a program analyzer configured to divide the computational program into subdivisions based on specific computational requirements of each part of the computational program, wherein the subdivisions are determined based on predefined types of computations, including but not limited to vector operations, matrix multiplications, Fast Fourier Transformations (FFT), and inverse FFTs;
a GPU resource matcher configured to determine a suitable type of GPU for each of said subdivisions of the computational program based on subdivision computational requirements, wherein the GPU resource matcher selects the GPU based on hardware architecture, including a number of cores, memory bandwidth, and clock speed of the GPUs;
a time predictor configured to predict when said subdivisions of the computational program will require GPU resources and duration of that need, wherein the time predictor estimates a required duration based on historical data of similar computational tasks and real-time performance metrics;
a GPU resource locator configured to locate available GPU resources in a marketplace, wherein the GPU resource locator identifies GPUs that meet the subdivision computational requirements and will be available at the predicted time, and wherein the marketplace includes cloud-based providers, private networks, and an auction-based system where GPU resources are offered at dynamically adjusted prices based on demand and availability;
a GPU optimizer configured to assess cost of the located GPU resources for the predicted time, wherein the GPU optimizer prioritizes the selection of GPUs that have the lowest power consumption while meeting computational requirements, and further considers a carbon footprint of a data center hosting the GPUs;
an allocation module configured to allocate selected GPU resources for said subdivisions of the computational program based on suitability, cost-effectiveness, power consumption, and carbon footprint, wherein the allocation is dynamically adjusted during execution based on real-time updates from a GPU consumer module;
a GPU consumer module configured to execute said subdivisions of the computational program on the allocated GPU resources, wherein the GPU consumer module monitors GPU utilization in real-time and updates a predicted completion time for each subdivision based on actual performance;
a monitoring module integrated with the GPU consumer module, configured to monitor the execution of each subdivision in real-time to ensure efficient GPU usage, wherein the monitoring module evaluates GPU health, including monitoring for overheating, underperformance, or hardware failure, and reports status to the GPU optimizer;
a dynamic adjustment module configured to adjust the allocation of GPU resources during the execution of the computational program in response to changes in resource availability, execution performance, or detected hardware issues, wherein unused or underutilized GPU resources are reallocated as needed;
a backup resource module configured to reserve backup GPU resources in event of hardware failure or unavailability during program execution to ensure uninterrupted performance of the computational program;
a cost-prediction module integrated with the GPU optimizer, configured to implement a dynamic cost-prediction model that estimates future GPU prices based on marketplace trends and historical pricing data, and adjusts the cost model in real-time to account for fluctuations in GPU pricing;
a marketplace module configured to enable users to rent out excess GPU resources in real-time, allowing dynamic role-switching between GPU consumer and GPU provider; and
a memory optimization module integrated with the program analyzer, configured to optimize the subdivisions of the computational program to minimize memory transfer bottlenecks between a CPU and GPU during execution.
